(19) United States
(12) Patent Application Publication
(10) Pub. No.: US 2026/0291939 A1
(43) Pub. Date: Sep. 24, 2026

(54) TRANSFER APPARATUS, INFORMATION PROCESSING SYSTEM, NON-TRANSITORY RECORDING MEDIUM, AND CLIENT APPARATUS

(71) Applicant: PFU LIMITED, Ishikawa (JP)

(72) Inventors: Takashi KOBAYASHI, Ishikawa (JP); Seigo TERADA, Ishikawa (JP)

(21) Appl. No.: 19/561,730

(22) Filed: Mar. 10, 2026

(30) Foreign Application Priority Data
Mar. 24, 2025 (JP) 2025-048022

(51) Int. Cl. H04L 9/40

(52) U.S. Cl. CPC H04L 63/10; H04L 63/08

(57) ABSTRACT

A transfer apparatus includes circuitry that obtains transfer destination information for designating a transfer destination of a response parameter related to an authentication/authorization response to an authentication/authorization request, the authentication/authorization request including an authorization request made for resource access by a client or a user authentication request made by the client, receives the response parameter included in the authentication/authorization response from an authentication/authorization server via a user agent, the authentication/authorization server being a server to perform authorization for the resource access or to perform user authentication, and transfers, via the user agent, the received response parameter to the transfer destination indicated by the obtained transfer destination information.

### CROSS-REFERENCE TO RELATED APPLICATIONS

This patent application is based on and claims priority pursuant to 35 U.S.C. § 119(a) to Japanese Patent Application No. 2025-48022, filed on Mar. 24, 2025, in the Japan Patent Office, the entire disclosure of which is hereby incorporated by reference herein.

### BACKGROUND

The present disclosure relates to technology for performing authentication or authorization.

JP-A-2019-046060 has proposed an authority transfer system including an authorization code request transmission unit and an authorization code response reception unit. The authorization code request transmission unit transmits an authorization code request, which is transmitted from a client to an authorization server to request the authorization server to authorize access to a resource server by the client. The authorization code response reception unit receives an authorization code response that is a response to the authorization code request. The authorization code request transmitted by the authorization code request transmission unit includes destination information for designating a response destination of the authorization code response. Signature information is attached to the destination information. Based on the destination information included in the authorization code request transmitted by the authorization code request transmission unit, the authorization server transmits the authorization code response to the authorization code request.

Examples of a protocol for authorizing an access right to a resource in the related art include Open Authorization (OAuth) 2.0. OAuth 2.0 is a mechanism for securely transferring an access right to a resource among services provided on the Internet. In OAuth 2.0, as preprocessing of an authorization process, a registration process is performed in which a client that requests access to a resource is preregistered in an authorization server that authorizes an access right to the resource. In this registration process, information such as a redirect Uniform Resource Identifier (URI) is registered as information on the client. The redirect URI is information for designating a redirect destination (i.e., a redirect destination expected by the client) of an authorization response (i.e., authorization code) from the authorization server. For example, an address of the client is registered as the redirect URI. In OAuth 2.0, the redirect URI preregistered in the authorization server is used to return an authorization response. There is an issue in that, when the address of the redirect destination of the authorization code changes due to, for example, a network environment, authorization response parameters such as the authorization code fail to be transmitted to the redirect destination. This issue also occurs in OpenID Connect (OIDC), which is a protocol that defines establishment of authentication via an OAuth 2.0 framework.

### SUMMARY

The transfer apparatus according to one aspect of the present disclosure includes circuitry that obtains transfer destination information for designating a transfer destination of a response parameter related to an authentication/authorization response to an authentication/authorization request, the authentication/authorization request including an authorization request made for resource access by a client or a user authentication request made by the client; receives the response parameter included in the authentication/authorization response from an authentication/authorization server via a user agent, the authentication/authorization server being a server to perform authorization for the resource access or to perform user authentication; and transfers, via the user agent, the received response parameter to the transfer destination indicated by the obtained transfer destination information.

The information processing system according to another aspect of the present disclosure includes an authentication/authorization server to perform authorization for resource access by a client or to perform authentication in response to a user authentication request made by the client, and a transfer apparatus. The authentication/authorization server includes a memory that stores information on the transfer apparatus, the information on the transfer apparatus being stored for the client as information on a delivery destination of a response parameter included in an authentication/authorization response to an authentication/authorization request, the authentication/authorization request including an authorization request made for the resource access by the client or the user authentication request; and first circuitry that receives the authentication/authorization request; and transmits the response parameter to the transfer apparatus via a user agent with reference to the information on the transfer apparatus. The transfer apparatus includes second circuitry that obtains transfer destination information for designating a transfer destination of the response parameter; receives the response parameter from the authentication/authorization server via the user agent; and transfers, via the user agent, the received response parameter to the transfer destination indicated by the obtained transfer destination information.

The non-transitory recording medium according to still another aspect of the present disclosure stores a plurality of instructions which, when executed by one or more processors, causes the one or more processors to perform a process. The process includes obtaining transfer destination information for designating a transfer destination of a response parameter related to an authentication/authorization response to an authentication/authorization request, the authentication/authorization request including an authorization request made for resource access by a client or a user authentication request made by the client; receiving the response parameter included in the authentication/authorization response from an authentication/authorization server via a user agent, the authentication/authorization server being a server to perform authorization for the resource access or to perform user authentication; and transferring, via the user agent, the received response parameter to the transfer destination indicated by the obtained transfer destination information.

The client apparatus according to still another aspect of the present disclosure includes circuitry that transmits transfer destination information for designating a transfer destination of a response parameter related to an authentication/authorization response to allow a transfer apparatus to obtain the transfer destination information. The transfer apparatus is an apparatus to receive, from an authentication/authorization server, the response parameter included in the authentication/authorization response to an authentication/authorization request. The authentication/authorization request includes an authorization request made for resource access by a client or a user authentication request made by the client. The authentication/authorization server is a server to perform authorization for the resource access or to perform user authentication.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an example of a hardware configuration of a system;

FIG. 2 is a schematic diagram illustrating an example of a functional configuration of the system;

FIG. 3 is a diagram illustrating an example of an overview of an authorization request in OAuth 2.0;

FIG. 4 is a diagram illustrating an example of an overview of an authorization response in OAuth 2.0;

FIG. 5 is a sequence diagram illustrating an example of an overview of a communication process flow in OAuth 2.0;

FIG. 6 is a sequence diagram illustrating an example of the overview of the communication process flow in OAuth 2.0;

FIG. 7 is a sequence diagram illustrating an example of the overview of the communication process flow in OAuth 2.0;

FIG. 8 is a diagram illustrating an example of a cooperation request screen;

FIG. 9 is a flowchart illustrating an example of an overview of a transfer setting process flow in a transfer server;

FIG. 10 is a diagram illustrating an example of an authentication/authorization screen (first page);

FIG. 11 is a diagram illustrating an example of the authentication/authorization screen (second page);

FIG. 12 is a diagram illustrating an example of a success notification screen;

FIG. 13 is a diagram illustrating an example of a case of sharing a client identifier;

FIG. 14 is a diagram illustrating an example of an overview of an authorization request (including a “request” parameter) in OAuth 2.0 according to a first variation;

FIG. 15 is a diagram illustrating an example of an overview of an authorization request (including a “request_uri” parameter) in OAuth 2.0 according to the first variation;

FIG. 16 is a diagram illustrating an example of an overview of an authorization request (a first request message) in OAuth 2.0 according to the first variation;

FIG. 17 is a diagram illustrating an example of an overview of an authorization request (a second request message) in OAuth 2.0 according to the first variation;

FIG. 18 is a sequence diagram illustrating an example of an overview of a communication process flow (after user authentication by an authorization server) in OAuth 2.0;

FIG. 19 is a sequence diagram illustrating an example of an overview of a communication process flow (after user authentication by the authorization server) in OAuth 2.0 according to a second variation;

FIG. 20 is a sequence diagram illustrating an example of an overview of a communication process flow in OAuth 2.0 according to a third variation;

FIG. 21 is a diagram illustrating an overview of an authorization request in OAuth 2.0 in the related art; and

FIG. 22 is a diagram illustrating an overview of an authorization response in OAuth 2.0 in the related art.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

A system, method, and program according to the embodiments will be described below with reference to the accompanying drawings. The embodiments described below are merely illustrative and do not limit the system, method, and program described herein to specific configurations described below. In the implementation, specific configurations may be adopted appropriately according to the mode of implementation, and various improvements and modifications may be made.

Herein, description will be given of embodiments in which the system, method, and program disclosed herein are implemented in a system for authorizing access to a resource using OAuth 2.0. However, the system, method, and program disclosed herein are widely applicable to a technique for authorizing access to a resource or a technique for performing user authentication, and the target to which the present disclosure is applied is not limited to the examples described in the embodiments.

Examples of a protocol for authorizing an access right to a resource in the related art include OAuth 2.0. For example, the use of OAuth 2.0 allows a user to permit access to authentication information of the user without disclosing the authentication information of the user to a third-party application (i.e., without sharing the authentication information of the user with a third party). In OAuth 2.0, as preprocessing performed before an authorization process is started, a registration process is performed in which a client that requests access to a resource is preregistered in an authorization server that authorizes an access right to the resource. In this registration process, information such as a client ID or a redirect URI is registered as information on the client. As described above, the redirect URI is information for designating a redirect destination of an authorization response (e.g., authorization code) from the authorization server, that is, information on a transition destination (i.e., delivery destination) serving as a site to receive a response parameter. For example, an address of the client is registered as the redirect URI. As described above, in OAuth 2.0, the redirect URI preregistered in the authorization server is used to return an authorization response. That is, the authorization server cannot redirect the authorization response to a destination that is not preregistered. This may involve an issue in that, when the address of the redirect destination of the authorization code changes due to, for example, a network environment, that is, the address of the redirect destination dynamically changes, the authorization server fails to transmit authorization response parameters (response parameters) such as the authorization code to the redirect destination expected by the client. An example of the case where the address changes is that the Internet Protocol (IP) address changes after the device is powered off and then powered on in a configuration where the IP address of the device serving as the redirect destination is automatically determined by Dynamic Host Configuration Protocol (DHCP). Another example is that the IP address of the redirect destination changes because the installed position of the device serving as the redirect destination is changed. An issue in OAuth 2.0 in the related art will be described by exemplifying an overview of a specific process in OAuth 2.0 in the related art.

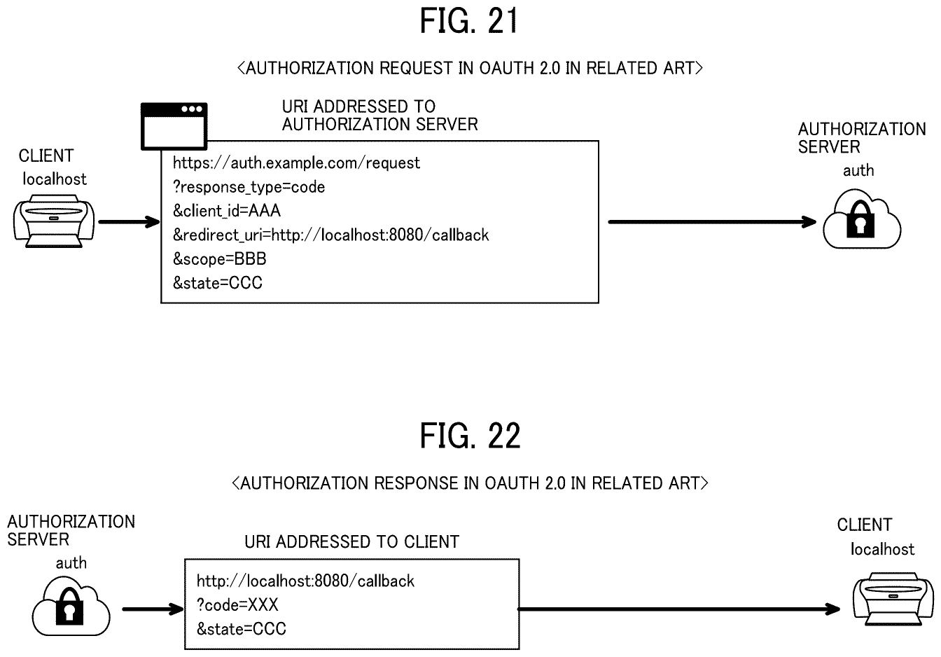

FIG. 21 is a diagram illustrating an overview of an authorization request in OAuth 2.0 in the related art. FIG. 21 illustrates an example case where a client (e.g., application) that requests access to a resource operates on an apparatus including a user agent for communicating with an external apparatus in response to a user operation. That is, FIG. 21 illustrates an example case where the client and the user agent operate on the same apparatus. In this example case, a web browser is exemplified as the user agent.

As illustrated in FIG. 21, in OAuth 2.0 in the related art, when receiving a resource access request from the web browser, the client transmits an authorization request to the authorization server via the web browser. Specifically, the client instructs the web browser to transmit an authorization request (i.e., authorization request message X) below to the authorization server. In FIG. 21, line breaks are added in the message X for display purposes (the same applies to other drawings). In the authorization request and the authorization response, a URI parameter is set using URI encoding in an “application/x-www-form-urlencoded” format. However, in the present embodiment and variations described below, for convenience of explanation, messages related to the authorization request and the authorization response are written in a URI-encoding-omitted format in the description of the messages.
(Message X)
GET https://auth.example.com/request?response_type=code&client_id=AAA&redirect_uri=http://localhost:8080/callback&scope=BBB&state=CCC

“https://auth.example.com/request” represents a URI of the authorization server (i.e., authorization endpoint). After the URI of the authorization server, a group of request parameters “response_type” (response type), “client_id” (client ID), “redirect_uri” (redirect URI), “scope” (scope), and “state” (state) are set. In the case of a request for an authorization code from the authorization server, “code” is set as the response type. The client ID is a client identifier of the client issued when the client is preregistered in the authorization server. A range of an access request is set as the scope. The state is a state value. The state included in a request and a response allows the client to verify that a state value included in the authorization request and a state value included in the authorization response are the same. Since FIG. 21 illustrates an example case where the client and the user agent operate on the same apparatus, “local host” is usable as the redirect URI as in http://localhost:8080/callback”. Here, “local host” indicates a host name or a domain name used in a computer network to designate the apparatus itself as a communication counterpart.

FIG. 22 is a diagram illustrating an overview of an authorization response in OAuth 2.0 in the related art. FIG. 22 illustrates an overview of the authorization response from the authorization server that has received the authorization request in FIG. 21. As illustrated in FIG. 22, in OAuth 2.0 in the related art, when receiving an authorization request, the authorization server returns an authorization response including an authorization code to the web browser to redirect the web browser to the client and deliver the authorization code to the client. Specifically, the authorization server returns an authorization response message Y below to the web browser.
(Message Y)
HTTP/1.1 302 Found Location: Http://localhost:8080/callback?code=xxx&state=ccc

As indicated in the message Y, a redirect URI “http://localhost:8080/callback” is set as a transition-destination URI in the “Location” header of the authorization response. After the transition-destination URI, a group of response parameters “code” (authorization code) and “state” (state) are set in the “Location” header. Accordingly, the web browser that has received the message Y accesses the path (/callback) of the apparatus of the web browser (localhost: 8080) with the group of response parameters (i.e., authorization code “XXX” and state “CCC”). This allows the client to receive the authorization code.

As described above, when the client and the user agent operate on the same apparatus, the use of “localhost” in the domain portion of the redirect URI allows the user agent to deliver an authorization response (i.e., authorization code) to the client even when the IP address of the client changes. However, when the client and the user agent operate on different terminals and the redirect destination is the client, “localhost” is not usable as the redirect URI. The IP address of the redirect destination (e.g., client) is to be registered as the redirect URI. When the client and the user agent operate on different terminals and the address of the client dynamically changes, the user agent fails to transfer the authorization response (i.e., authorization code) to the client because the address of the client as viewed from the user agent changes. That is, since the address of the client (i.e., redirect destination) differs from the address (i.e., redirect URI) preregistered in the authorization server, the authorization server (user agent) fails to transmit (transfer) the authorization response parameters such as the authorization code to the redirect destination expected by the client.

The above-described issue also occurs in OIDC, which is a protocol that defines establishment of authentication via an OAuth 2.0 framework. Specifically, when the address of the redirect destination of the authorization code changes due to, for example, the network environment, an issue occurs in that an OpenID Provider (OP) fails to transfer the authentication response parameters (response parameters) such as the authorization code to the redirect destination expected by a Relying Party (RP). The OpenID Provider is an entity that provides an authentication function and issues an ID token in response to an authentication request, and corresponds to the authorization server in OAuth 2.0. The Relying Party is an application that uses the authentication function, and corresponds to the client in OAuth 2.0.

Accordingly, in view of the issues described above, in a system according to embodiments, a transfer apparatus receives a response parameter related to an authentication/authorization response from an authentication/authorization server, and transfers the response parameter to a transfer destination indicated by transfer destination information (i.e., a redirect destination expected by a client). The system enables the response parameter to be transmitted to the destination expected by the client even when the address of the destination expected by the client changes (i.e., when the address of the redirect destination as viewed from the user agent changes). That is, the redirect URI registered in the authentication/authorization server is the URI of the transfer apparatus. This allows the transfer apparatus to first receive the response parameter and then transfer the response parameter to the transfer destination indicated by the transfer destination information. This enables transfer of the response parameter to the redirect destination expected by the client. Consequently, labor for performing processing of changing the redirect URI preregistered in the authorization server to the new address (requesting the authorization server to change the redirect URI) can be saved even when the address of the redirect destination expected by the client (e.g., the URI of the client) changes.

JP-A-2019-046060 has proposed an authority transfer system, which uses a signature of the client to prevent an authorization request from being altered, without determining whether response destination information requested by the client matches response destination information preregistered in the authorization server, which is usually performed in an authorization server. The authority transfer system in the related art also allows an authorization server to trust the response destination information (i.e., redirect URI) included in the authorization request by verifying the signature. However, the authority transfer system in the related art changes the existing processing of authorization servers, and has an issue of incompatibility with existing authorization servers. When an authorization request is made to an external existing authorization server, it is difficult to eliminate complexity of a process performed when the redirect-destination URI changes (complexity of requesting the authorization server to change the redirect URI). In contrast, a system according to embodiments does not change existing processing of existing authorization servers, and can provide advantageous effects described above even when external existing authorization servers are used.

### System Configuration

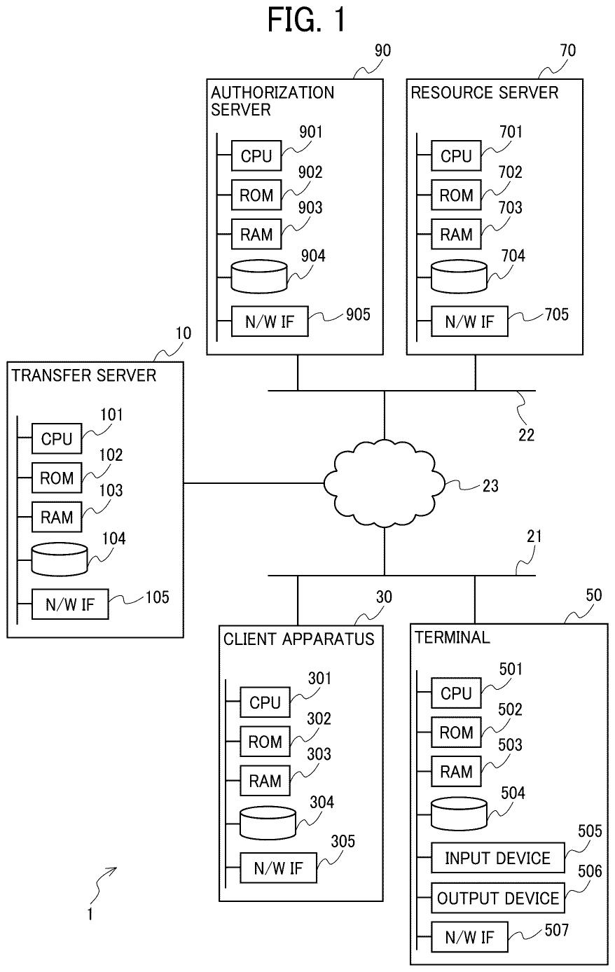

FIG. 1 is a schematic diagram illustrating an example of a hardware configuration of a system according to an embodiment. A system 1 according to the present embodiment includes a transfer server 10, a client apparatus 30, a terminal 50, a resource server 70, and an authorization server 90 that are communicably connected to one another via a network or any other communication scheme. The system 1 is an example of an information processing system in the present disclosure. The transfer server 10 is an example of a transfer apparatus in the present disclosure. As illustrated in FIG. 1, the client apparatus 30 and the terminal 50 are connected to each other via a local area network (LAN) 21. The resource server 70 and the authorization server 90 are connected to each other via a LAN 22. The transfer server 10, the client apparatus 30, the terminal 50, the resource server 70, and the authorization server 90 are connected to one another via a wide area network (WAN) 23. The transfer server 10, the client apparatus 30, the terminal 50, the resource server 70, and the authorization server 90 may be communicably connected to one another via any communication scheme. FIG. 1 illustrates the resource server 70 and the authorization server 90 as different servers (different apparatuses). In another embodiment, the resource server 70 and the authorization server 90 may be implemented by a single (same) server having the function of the resource server 70 and the function of the authorization server 90. The system 1 may include multiple clients.

The system 1 uses OAuth 2.0 to authorize access to a resource managed by the resource server 70. An example case where authorization is performed using an authorization code flow of OAuth 2.0 (a flow defined in RFC 6749 Section 4.1) will be described below. In the authorization code flow of OAuth 2.0, the authorization server 90 receives an authorization request from a client application of the client apparatus 30, and issues an authorization code to the client application as a response to the authorization request. The client application obtains the authorization code and presents the authorization code to the authorization server 90. The authorization server 90 then issues an access token to the client application. An access token is credentials used to access a protected resource, and is data (e.g., character string) indicating permission to access the resource. The technique according to the embodiments is also applicable to authentication in OIDC in addition to authorization in OAuth 2.0. In the case of OIDC, the components, namely, “authorization server”, “resource server”, “access token”, and “client” in OAuth 2.0 according to the present embodiment may be read as “OpenID Provider (OP)”, “UserInfo Endpoint (of the OpenID Provider)”, “ID token (proof indicating that a user has been authenticated)”, and “Relying Party (RP)”, respectively.

The transfer server 10 is an apparatus that receives, from the authorization server 90, a response (i.e., response parameter) to an authentication/authorization request and transfers the response to a transfer destination (i.e., destination expected by the client). In the present embodiment, a user authentication request (i.e., an authentication request by the RP in OIDC) or an authorization request for resource access (i.e., an authorization request by the client in OAuth 2.0) is referred to as an “authentication/authorization request”. In the present embodiment, an authorization request for resource access is exemplified as the authentication/authorization request, but the authentication/authorization request may be an authentication request. In the present embodiment, a server (i.e., transfer server) is exemplified as the transfer apparatus, but the transfer apparatus is not limited to a server. The transfer server 10 is a computer including a central processing unit (CPU) 101, a read-only memory (ROM) 102, a random access memory (RAM) 103, a storage device 104 such as an electrically erasable programmable read-only memory (EEPROM) and a hard disk drive (HDD), and a communication unit 105 such as a network interface (N/W IF) implemented by a network interface card (NIC). A specific hardware configuration of the transfer server 10 can be appropriately omitted, replaced, or added according to the mode of implementation. For example, the transfer server 10 may include an input device such as a keyboard, a mouse, or a touch panel, and an output device such as a display. The transfer server 10 is not limited to an apparatus having a single housing, and may be implemented by multiple apparatuses using, for example, a so-called cloud or distributed computing technology.

The client apparatus 30 is an apparatus including an application (i.e., client application) that requests access to a protected resource. A client application 31 of the client apparatus 30 corresponds to a client in OAuth 2.0. Hereinafter, the client application 31 of the client apparatus 30 is simply referred to as a “client”. The term “client” encompasses a Relying Party, which is an OpenID Connect client. The client (i.e., client application) 31 makes an authorization request to the authorization server 90 via a user agent to obtain an authorization code from the authorization server 90. The client 31 uses the obtained authorization code to receive an access token from the authorization server 90. The client 31 presents the access token to the resource server 70 to request access to a resource. Consequently, the client 31 is authorized to access the resource protected by the resource server 70. The client apparatus 30 is a computer including a CPU 301, a ROM 302, a RAM 303, a storage device 304, and a communication unit 305 such as a network interface (N/W IF). A specific hardware configuration of the client apparatus 30 can be appropriately omitted, replaced, or added according to the mode of implementation. For example, the client apparatus 30 may include an input device such as a keyboard, a mouse, or a touch panel, and an output device such as a display. The client apparatus 30 is not limited to an apparatus having a single housing, and may be implemented by multiple apparatuses using, for example, a so-called cloud or distributed computing technology. The client apparatus 30 may be any given apparatus that has the client application 31, for example, a printer, a scanner, a multifunction peripheral (MFP), a personal computer (PC), a tablet, or a smartphone. For example, as the client apparatus 30, a scanner including, as the client 31, an application that saves scan data (i.e., scanned image) directly from the scanner to a cloud storage service (i.e., the resource server 70) is exemplified.

The terminal 50 is an apparatus including a user agent that is a program (software) for communicating with an external apparatus in response to a user operation. In the present embodiment, a web browser 51 is exemplified as the user agent, but the user agent may be, for example, a download manager, a bot, or another program for accessing the web. The user can request access to a resource by operating the terminal 50 (i.e., the web browser 51). The web browser 51 of the terminal 50 corresponds to a user agent in OAuth 2.0. The terminal 50 is a computer including a CPU 501, a ROM 502, a RAM 503, a storage device 504, an input device 505 such as a keyboard, a mouse, or a touch panel, an output device 506 such as a display, and a communication unit 507 such as a network interface (N/W IF). A specific hardware configuration of the terminal 50 can be appropriately omitted, replaced, or added according to the mode of implementation. The terminal 50 is not limited to an apparatus having a single housing, and may be implemented by multiple apparatuses using, for example, a so-called cloud or distributed computing technology. The terminal 50 may be any given apparatus including the user agent, for example, a PC, a tablet, or a smartphone.

The resource server 70 is a server that manages (protects) a resource. The resource server 70 may be a server that provides any given service such as a storage service or a business service. As the resource server 70, a server that provides a cloud storage service is exemplified. However, the resource server 70 may be a server that provides a service other than the cloud storage service. When receiving, from the client 31, an access request to a resource (e.g., a resource request using an access token), the resource server 70 verifies the validity of the access token received from the client 31. When the access token is valid, the resource server 70 responds to the request. For example, the resource server 70 returns the requested resource to the client 31. The resource managed by the resource server 70 may be any given resource. “Resource access” includes storing data in a folder of the resource server 70 as well. The resource server 70 is a computer including a CPU 701, a ROM 702, a RAM 703, a storage device 704, and a communication unit 705 such as a network interface (N/W IF). A specific hardware configuration of the resource server 70 can be appropriately omitted, replaced, or added according to the mode of implementation. For example, the resource server 70 may include an input device such as a keyboard, a mouse, or a touch panel, and an output device such as a display. The resource server 70 is not limited to an apparatus having a single housing, and may be implemented by multiple apparatuses using, for example, a so-called cloud or distributed computing technology.

The authorization server 90 is a server that performs authorization related to resource access. The authorization server 90 issues an authorization code and an access token to the client 31 that requests access to a resource. The authorization server 90 is a computer including a CPU 901, a ROM 902, a RAM 903, a storage device 904, and a communication unit 905 such as a network interface (N/W IF). A specific hardware configuration of the authorization server 90 can be appropriately omitted, replaced, or added according to the mode of implementation. For example, the authorization server 90 may include an input device such as a keyboard, a mouse, or a touch panel, and an output device such as a display. The authorization server 90 is not limited to an apparatus having a single housing, and may be implemented by multiple apparatuses using, for example, a so-called cloud or distributed computing technology. The authorization server 90 is an example of an “authentication/authorization server (i.e., authentication/authorization server that performs authorization for resource access or performs user authentication)” according to the embodiments. The authentication/authorization server may be an authorization server (i.e., the authorization server 90) in OAuth 2.0 or an OpenID Provider (authentication server) in OIDC.

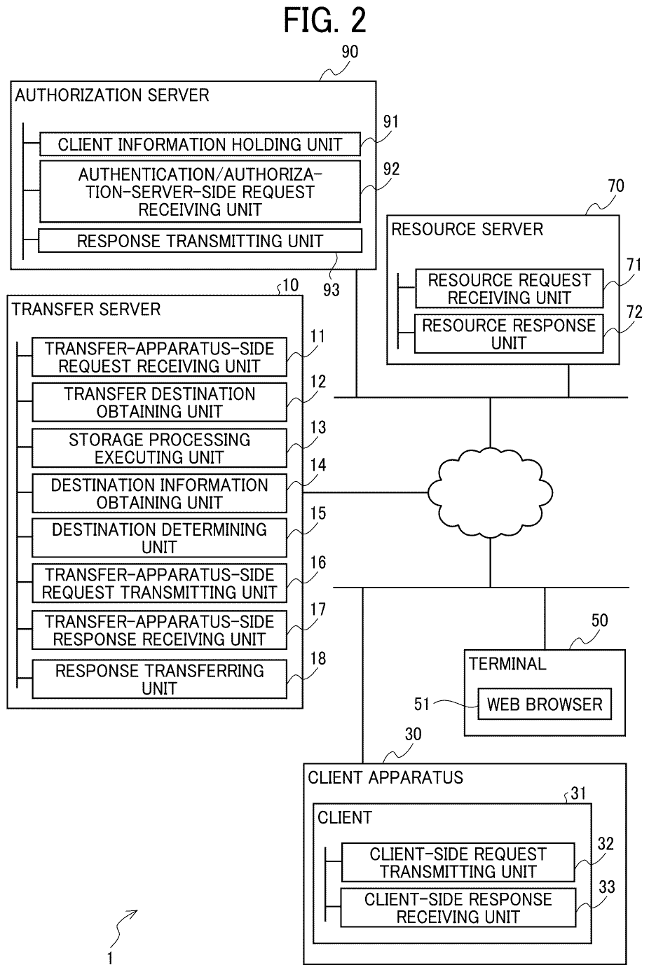

FIG. 2 is a schematic diagram illustrating an example of a functional configuration of the system according to the present embodiment. The CPU 101 of the transfer server 10 reads a program recorded in the storage device 104 to the RAM 103 and executes the program, so that the pieces of hardware of the transfer server 10 are controlled. Consequently, the transfer server 10 functions as an information processing apparatus including a transfer-apparatus-side request receiving unit 11, a transfer destination obtaining unit 12, a storage processing executing unit 13, a destination information obtaining unit 14, a destination determining unit 15, a transfer-apparatus-side request transmitting unit 16, a transfer-apparatus-side response receiving unit 17, and a response transferring unit 18. Note that in the present embodiment and variations described below, the functions of the transfer server 10 are executed by the CPU 101 which is a general-purpose processor. However, some or all of these functions may be executed by one or more dedicated processors. In addition, some or all of these functions may be executed by an apparatus installed at a remote location or by multiple apparatuses installed in a distributed manner by using cloud technology.

The transfer-apparatus-side request receiving unit 11 receives one or more request messages for an authentication/authorization request. The transfer-apparatus-side request receiving unit 11 corresponds to a “request receiving unit” of a transfer apparatus in the present application. The request message for an authentication/authorization request is a message transmitted to make the authentication/authorization request, and corresponds to a message for an authentication request or a message for an authorization request. In the present embodiment, a message for an authorization request is exemplified as the request message. The transfer-apparatus-side request receiving unit 11 receives the request message from a user agent (i.e., web browser 51) or the client 31. In the present embodiment, an example case where the request message is received from the web browser 51 will be described.

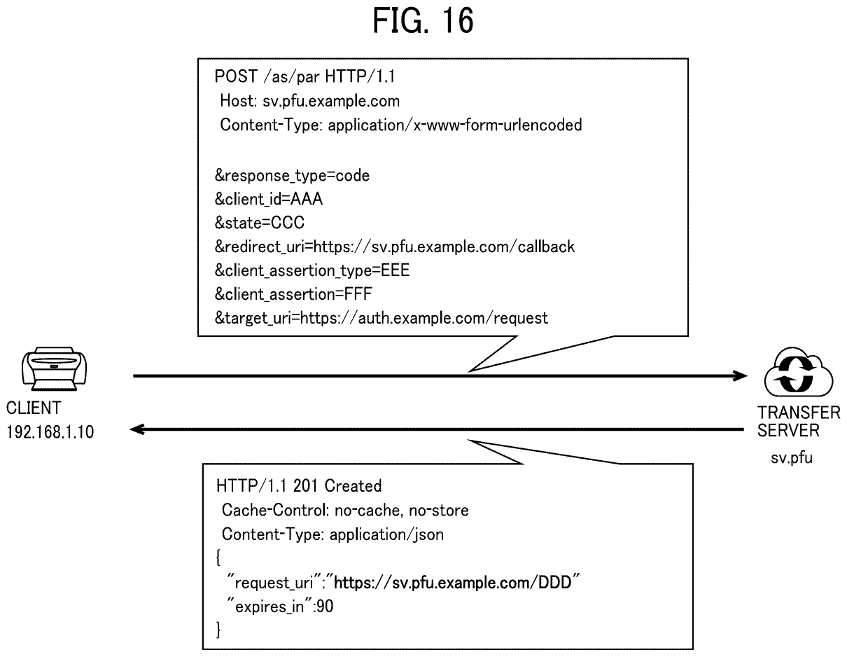

In the present embodiment, when a user makes a resource access request (e.g., service cooperation request) on the web browser 51, the client 31 generates a group of parameters related to an authorization request (hereinafter referred to as a “group of request parameters”). The client 31 then sends, to the user agent, a message including the group of request parameters (e.g., a response message using a Hypertext Transfer Protocol (HTTP) status code related to redirection). At this time, the client 31 sets, in the response message, parameters used by the transfer server 10 for transfer (hereinafter referred to as “transfer parameters”) in addition to the group of request parameters. Specifically, as the transfer parameters, a URI of the authorization server 90 (i.e., authorization endpoint) to which authorization (authentication) is requested and a URI of a transfer destination (i.e., response destination) of response parameters expected by the client 31 are set. In the “Location” header of the response message, the URI of the transfer server 10 is set as the redirect destination. The user agent that has received the response message is redirected to the transfer server 10. Consequently, the transfer server 10 receives, from the user agent, an HTTP message (e.g., an HTTP message using a “GET” method (i.e., GET message)) that is a request message for an authorization request. Details of the request message received from the user agent will be described below (see a message B). A case where the transfer server 10 receives the request message for an authorization request from the client 31 will be described in a first variation (FIG. 16) described below.

The transfer destination obtaining unit 12 obtains transfer destination information for designating a transfer destination of response parameters related to an authentication/authorization response to an authentication/authorization request. In the present embodiment, the transfer destination obtaining unit 12 obtains the transfer destination information from one request message included in one or more request messages obtained by the transfer-apparatus-side request receiving unit 11. The authentication/authorization response corresponds to an authorization response to an authorization request or an authentication response to an authentication request. In the present embodiment, an authorization response is exemplified as the authentication/authorization response. In the transfer destination information, a destination (i.e., response destination) expected by the client 31 is designated as the transfer destination of the response parameters from the transfer server 10. As described below, the transfer server 10 that has received the response parameters from the authorization server 90 transfers the response parameters to the transfer destination indicated by the transfer destination information. The transfer destination of the response parameters may be, for example, the client 31 itself (such as a part of the client 31) or may be an application (program) different from the client 31. As described above, the URI of the destination expected by the client 31 may dynamically change by DHCP. The transfer destination information is not information that is preregistered in the authorization server 90, and is instructed to the transfer server 10 when an authorization process is performed. The transfer destination obtaining unit 12 may obtain the transfer destination information via the user agent from the authorization server 90 that has received the authorization request including the transfer destination information. The transfer destination obtaining unit 12 may obtain the transfer destination information from a notification message of the transfer destination information that is received by the transfer server 10 after the response parameters are received by the transfer-apparatus-side response receiving unit 17.

The storage processing executing unit 13 executes a process for storing, in a storage device, the transfer destination information obtained by the transfer destination obtaining unit 12 as information related to the authentication/authorization request. The storage device that stores the transfer destination information may be a storage device inside the transfer apparatus (i.e., the transfer server 10) or may be a storage device outside the transfer apparatus (i.e., the transfer server 10). In the present embodiment, the storage processing executing unit 13 executes a process for saving (storing) the transfer destination information in a cookie that is stored in the web browser 51 of the terminal 50. For example, the storage processing executing unit 13 performs a process for including, in a message transmitted from the transfer server 10 to the user agent, an instruction message (e.g., Set-Cookie) for storing the transfer destination information in a cookie. For example, the storage processing executing unit 13 may manage the transfer destination information as session information. Specifically, the storage processing executing unit 13 may cause a storage device (e.g., the storage device 104) in the transfer server 10 to store the transfer destination information in association with a session ID, and may provide an instruction to store the session ID in a cookie of the web browser 51. When the transfer destination information is held as a cookie of the web browser 51 or as session information in this manner, the storage processing executing unit 13 may function as a part of the transfer-apparatus-side request transmitting unit 16 described below. In another method, the storage processing executing unit 13 may perform a process for causing an external storage device accessible by the transfer server 10 to store the transfer destination information.

The destination information obtaining unit 14 obtains destination information designating an authentication/authorization server (i.e., the authorization server 90) as the destination of an authentication/authorization request. In the present embodiment, the destination information obtaining unit 14 obtains the destination information from one request message included in one or more request messages obtained by the transfer-apparatus-side request receiving unit 11. In a configuration, the client 31 does not designate the authorization server 90 each time, for example, the transfer server 10 performs a transfer process with the authorization server 90 determined in advance. In such a configuration, the destination information obtaining unit 14 may obtain information (URI) on the authorization server 90 held in advance in the transfer server 10 from, for example, the storage device 104 of the transfer server 10.

The destination determining unit 15 determines whether the destination indicated by the destination information obtained by the destination information obtaining unit 14 is a destination permitted as the transmission destination of the authentication/authorization request. For example, the determination is made based on a list (hereinafter referred to as a “permission list”) that is held in the transfer server 10 and collectively includes information on authorization servers permitted as destinations to which an authentication/authorization request is transmitted (transferred). Specifically, the destination determining unit 15 determines whether the permission list includes the destination indicated by the obtained destination information to determine whether the destination is a permitted destination.

The transfer-apparatus-side request transmitting unit 16 transmits, to the authentication/authorization server (i.e., the authorization server 90) via the user agent, request parameters (i.e., authentication/authorization request parameters) related to an authentication/authorization request received by the transfer-apparatus-side request receiving unit 11. The transfer-apparatus-side request transmitting unit 16 corresponds to a “request transmitting unit” of a transfer apparatus in the present application. Specifically, the transfer-apparatus-side request transmitting unit 16 instructs the user agent to transmit, to the authentication/authorization server, an authentication/authorization request including the request parameters included in one or more request messages received by the transfer-apparatus-side request receiving unit 11 or including information that enables identification of the request parameters. The transfer-apparatus-side request transmitting unit 16 transmits, to the authentication/authorization server via the user agent, the request parameters or the information that enables identification of the request parameters. The request parameters are authorization request parameters related to an authorization request or authentication request parameters related to an authentication request. As the request parameters, parameters such as “response_type” (response type), “client_id” (client ID), “redirect_uri” (redirect URI), “scope” (scope), and “state” (state) are exemplified. In the present embodiment, the URI of the transfer server 10 is set as the redirect URI. The request parameters are not limited to the exemplified parameters, and may be appropriately added or omitted. Details of the request parameters will be described below. As the “information that enables identification of parameters”, a “request” parameter having a value of a JSON web token (JWT) that collectively includes multiple request parameters such as the redirect URI and a “request_uri” parameter having, as a value, a URI referring to the JWT are exemplified. Transmitting the request parameters also includes a case where, when the transfer-apparatus-side request receiving unit 11 receives, as the request parameter, the “request” parameter or the “request_uri” parameter, the transfer-apparatus-side request transmitting unit 16 transmits the request parameter. Details of a message transmitted by the transfer-apparatus-side request transmitting unit 16 will be described below (see a message C).

The transfer-apparatus-side request transmitting unit 16 instructs the user agent using the destination information obtained by the destination information obtaining unit 14 to transmit the authentication/authorization request to the authentication/authorization server (i.e., the authorization server 90) indicated by the destination information. In the present embodiment, when the destination determining unit 15 determines that the destination indicated by the obtained destination information is a destination permitted as the transmission destination of the authentication/authorization request, the transfer-apparatus-side request transmitting unit 16 instructs the user agent to transmit the authentication/authorization request to the authentication/authorization server.

The transfer-apparatus-side response receiving unit 17 receives, from the authentication/authorization server (i.e., the authorization server 90) via the user agent, response parameters included in an authentication/authorization response. The transfer-apparatus-side response receiving unit 17 corresponds to a “response receiving unit” of a transfer apparatus in the present application. As described above, in the present embodiment, the URI of the transfer server 10 is set as the redirect URI. The user agent that has received an authorization response (i.e., an authorization response message in which the transfer server 10 is set as the redirect destination in the “Location” header) from the authorization server 90 is redirected to the transfer server 10. Consequently, (a group of) response parameters included in the authorization response is delivered to the transfer server 10. The transfer-apparatus-side response receiving unit 17 can receive the response parameters from the authorization server 90 via the user agent. The response parameters are authorization response parameters related to an authorization response or authentication response parameters related to an authentication response. In the present embodiment, “code” (authorization code) and “state” (state) are exemplified as the (group of) response parameters. However, the (group of) response parameters are not limited to these parameters, and may be appropriately added or omitted. The response parameters according to the present embodiment include at least an authorization code. The authorization code is a temporary code (that is valid for a short period) for obtaining an access token (ID token). Details of a message received by the transfer-apparatus-side response receiving unit 17 will be described below (see a message F).

The response transferring unit 18 transfers, via the user agent, the response parameters (e.g., the authorization code and the state) received by the transfer-apparatus-side response receiving unit 17 to the transfer destination indicated by the transfer destination information obtained by the transfer destination obtaining unit 12. In the present embodiment, the response transferring unit 18 transfers the response parameters to the transfer destination indicated by the transfer destination information with reference to the transfer destination information stored in a storage mechanism (e.g., a cookie of the web browser 51). Specifically, with reference to the transfer destination information included in a message received by the transfer-apparatus-side response receiving unit 17 from the web browser 51 (i.e., the transfer destination information held in a cookie of the web browser 51), the response transferring unit 18 transfers the response parameters to the transfer destination indicated by the transfer destination information. Details of a message transmitted by the response transferring unit 18 will be described below (see a message G).

The CPU 301 of the client apparatus 30 reads a program recorded in the storage device 304 to the RAM 303 and executes the program, so that the pieces of hardware of the client apparatus 30 are controlled. Consequently, the client apparatus 30 functions as an information processing apparatus including a client-side request transmitting unit 32 and a client-side response receiving unit 33. Note that in the present embodiment and variations described below, the functions of the client apparatus 30 are executed by the CPU 301 which is a general-purpose processor. However, some or all of these functions may be executed by one or more dedicated processors. In addition, some or all of these functions may be executed by an apparatus installed at a remote location or by multiple apparatuses installed in a distributed manner by using cloud technology.

The client-side request transmitting unit 32 generates a group of request parameters and transfer parameters, and transmits, to the user agent, a message including the group of request parameters and the transfer parameters (i.e., a response message using an HTTP status code related to redirection (e.g., 302)). In the response message, the transfer server 10 (i.e., the URI of the transfer server 10) is set as the redirect destination (i.e., transition destination). That is, the client 31 transmits the group of request parameters and the transfer parameters to the transfer server 10 via the web browser 51. Details of the response message transmitted by the client-side request transmitting unit 32 will be described below (see a message A). The client-side request transmitting unit 32 uses an authorization code obtained from the authorization server 90 to request an access token from the authorization server 90. The client-side request transmitting unit 32 presents the access token obtained from the authorization server 90 to the resource server 70 to make a resource request. In the present embodiment, a case where the client 31 transmits the transfer destination information to the transfer server 10 together with the group of request parameters is exemplified. However, as in a second variation described below, the client 31 may transmit the transfer destination information to the transfer server 10 after an authorization response is provided.

The client-side response receiving unit 33 receives (a group of) response parameters from the transfer server 10 via the user agent. Specifically, the client-side response receiving unit 33 receives a message (including the response parameters) transmitted from the user agent as a result of the transfer server 10 redirecting the web browser 51 to the client 31, and receives the response parameters. Details of a message received by the client-side response receiving unit 33 will be described below (see a message H). The client-side response receiving unit 33 obtains an access token from the authorization server 90. The client-side response receiving unit 33 further receives a resource response from the resource server 70.

The CPU 701 of the resource server 70 reads a program recorded in the storage device 704 to the RAM 703 and executes the program, so that the pieces of hardware of the resource server 70 are controlled. Consequently, the resource server 70 functions as an information processing apparatus including a resource request receiving unit 71 and a resource response unit 72. Note that in the present embodiment and variations described below, the functions of the resource server 70 are executed by the CPU 701 which is a general-purpose processor. However, some or all of these functions may be executed by one or more dedicated processors. In addition, some or all of these functions may be executed by an apparatus installed at a remote location or by multiple apparatuses installed in a distributed manner by using cloud technology.

The resource request receiving unit 71 receives, from the client 31, a resource request including an access token.

When the resource request receiving unit 71 receives the resource request, the resource response unit 72 makes a resource response (provides a service).

The CPU 901 of the authorization server 90 reads a program recorded in the storage device 904 to the RAM 903 and executes the program, so that the pieces of hardware of the authorization server 90 are controlled. Consequently, the authorization server 90 functions as an information processing apparatus including a client information holding unit 91, an authentication/authorization-server-side request receiving unit 92, and a response transmitting unit 93. Note that in the present embodiment and variations described below, the functions of the authorization server 90 are executed by the CPU 901 which is a general-purpose processor. However, some or all of these functions may be executed by one or more dedicated processors. In addition, some or all of these functions may be executed by an apparatus installed at a remote location or by multiple apparatuses installed in a distributed manner by using cloud technology.

The client information holding unit 91 holds information on the transfer server 10 (e.g., the URI of the transfer server 10) as the information (e.g., the redirect URI) on the delivery destination of the response parameters for the client 31. As preprocessing of an authorization process in OAuth 2.0, a registration process of the client 31 in the authorization server 90 is performed (the same applies to an authentication process in OIDC). In the registration process of the client 31, in response to the authorization server 90 receiving a registration request for registering the client 31, the authorization server 90 issues, to the client 31, a client ID for identifying the client and a client secret that is a secret key used together with the client ID. In the registration process of the client 31, the redirect URI for the client 31 is presented, for example, from the client 31 to the authorization server 90. The client information holding unit 91 holds (registers) the client ID, the client secret, and the redirect URI in association with one another.

The authentication/authorization-server-side request receiving unit 92 receives an authentication/authorization request. The authentication/authorization-server-side request receiving unit 92 corresponds to a “request receiving unit” of an authentication/authorization server in the present application. Details of the authorization request received by the authentication/authorization-server-side request receiving unit 92 will be described below (see a message D).

The response transmitting unit 93 transmits the response parameters to the transfer server 10 via the user agent with reference to the information (URI) on the transfer server 10 that is information on the delivery destination (redirect URI) of the response parameters. Specifically, the response transmitting unit 93 transmits, to the web browser 51, an authorization response designating the transfer server 10 as the delivery destination (i.e., redirect destination) of the response parameters to redirect the web browser 51 to the transfer server 10, and transmits the response parameters included in the authorization response to the transfer server 10. At this time, with reference to the redirect URI (i.e., the URI of the transfer server 10) preregistered for the client 31, the response transmitting unit 93 transmits the authorization response in which the redirect URI is set as the redirect destination. In the authorization code flow of OAuth 2.0, upon receiving an authorization request including a client ID and a redirect URI, the authorization server 90 determines whether a combination of the client ID and the redirect URI included in the authorization request matches a combination of a client ID and a redirect URI preregistered. As a result of the determination, when the combinations match, the authorization server 90 makes an authorization response using the redirect URI. Details of the authorization response transmitted by the response transmitting unit 93 will be described below (see a message E).

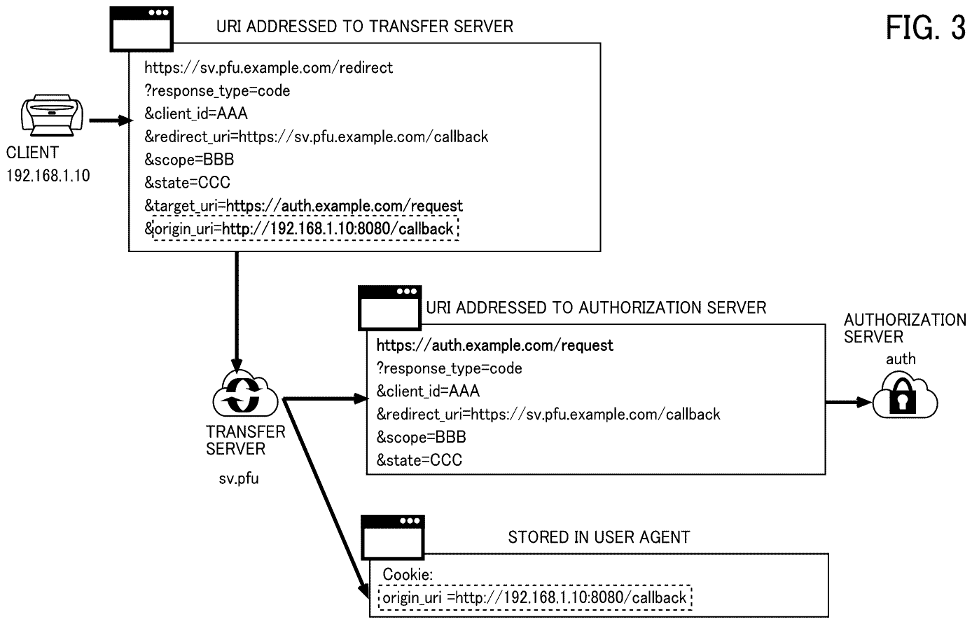

FIG. 3 is a diagram illustrating an example of an overview of an authorization request in OAuth 2.0 according to the present embodiment. FIG. 3 illustrates an example case where the client 31 that requests access to a resource operates on the client apparatus 30 that is an apparatus different from the terminal 50 including a user agent. In this example case, the web browser 51 is exemplified as the user agent.

As illustrated in FIG. 3, in OAuth 2.0 according to the present embodiment, when receiving a resource access request from the web browser 51, the client 31 transmits, to the transfer server 10 via the web browser 51, an authorization request transfer request (i.e., a request to transmit (transfer) an authorization request to the authorization server 90). Specifically, the client 31 instructs the web browser 51 to transmit, to the transfer server 10, an authorization request transfer request (e.g., authorization request transfer request message a) below.
(Message a)
GET https://sv.pfu.example.com/redirect?
response_type=code&client_id=AAA&redirect_uri=https://sv.pfu.example.com/
callback&scope=BBB&state=CCC&target_uri=https://auth.example.com/
request&origin_uri=http://192.168.1.10:8080/callback

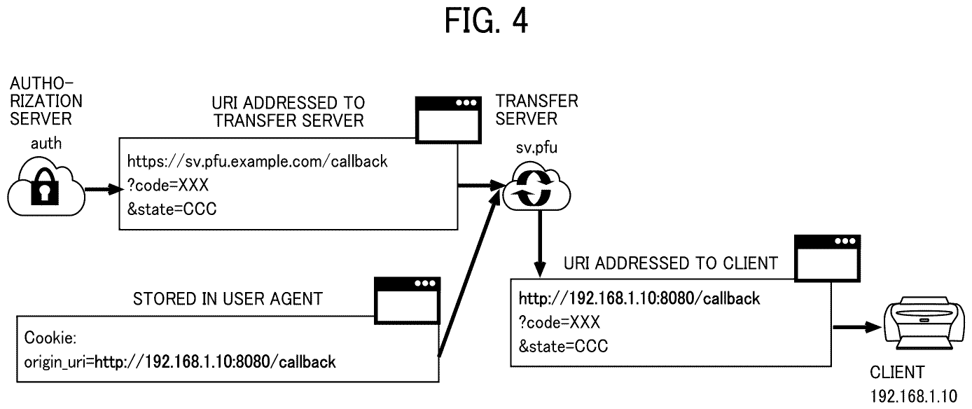

“https://sv.pfu.example.com/redirect” indicates the URI that designates a transfer request path of the transfer server 10. After the URI of the transfer server 10, the response type, the client ID, the redirect URI, the scope, and the state are set as the group of request parameters. In the example of FIG. 3, “https://sv.pfu.example.com/callback”, which is the URI of the transfer server 10 (i.e., the URI that designates the response transfer path of the transfer server 10), is set in the redirect URI. As illustrated in FIG. 4, an authorization response is transferred to the transfer server 10. In the present embodiment, as indicated in the message a, “target_uri” (destination information) and “origin_uri” (transfer destination information) are delivered to the transfer server 10 as transfer parameters. The “target_uri” indicates the URI of the authorization server 90 (i.e., authorization endpoint), and corresponds to “https://auth.example.com/request” in the message a. The “origin_uri” indicates the URI of the redirect destination expected by the client 31 (in FIG. 3, the client 31), and corresponds to “http://192.168.1.10:8080/callback” in the message a.

The transfer server 10 that has received the message a rewrites the redirect destination of the message a and performs redirection. Specifically, the transfer server 10 transmits, to the web browser 51, an HTTP message b below in which the “target_uri” included in the message a is set as the redirect destination to redirect the web browser 51 to the authorization server 90. Thus, an authorization request is made to the authorization server 90 from the web browser 51. The transfer server 10 also manages a session of the “origin_uri” included in the message a. For example, the transfer server 10 causes the web browser 51 to hold the “origin_uri” in a cookie.
(Message b)
HTTP/1.1 302 Found Location: https://auth.example.com/request?response_type=code&client_id=AAA&redirect_uri=https://sv.pfu.example.com/callback&scope=BBB&state=CCC

As described above, the message b includes the group of request parameters included in the message a. The web browser 51 that has received the message b accesses an endpoint of the authorization server 90 with the group of request parameters. This allows the authorization server 90 to receive the authorization request.

FIG. 4 is a diagram illustrating an example of an overview of an authorization response in OAuth 2.0 according to the present embodiment. FIG. 4 illustrates an overview of the authorization response from the authorization server 90 that has received the authorization request in FIG. 3. As illustrated in FIG. 4, in OAuth 2.0 according to the present embodiment, when receiving the authorization request, the authorization server 90 returns an authorization response including an authorization code to the web browser 51 to redirect the web browser 51 not to the client 31 but to the transfer server 10. Specifically, the authorization server 90 returns, to the web browser 51, an authorization response message c below.
(Message c)
HTTP/1.1 302 Found Location: https://sv.pfu.example.com/callback?code=XXX&state=CCC

As indicated in the message c, a redirect URI “https://sv.pfu.example.com/callback” is set as the transition-destination URI in the “Location” header of the authorization response. Accordingly, the web browser 51 that has received the message c accesses the response transfer path of the transfer server 10 with the group of response parameters (i.e., authorization code “XXX” and state “CCC”). The web browser 51 returns, to the transfer server 10, information (i.e., origin_uri) held in the cookie in response to an instruction of the transfer server 10. The transfer server 10 that has obtained the group of response parameters and the “origin_uri” from the web browser 51 rewrites the redirect destination of the message c and performs redirection. Specifically, the transfer server 10 transmits, to the web browser 51, an HTTP message d in which the origin_uri obtained from the web browser 51 is set as the redirect destination to redirect the web browser 51 to the transition destination (i.e., the client 31).
(Message d)
HTTP/1.1 302 Found Location: http://192.168.1.10:8080/callback?code=XXX&state=CCC

As indicated in the message d, the origin_uri “http://192.168.1.10:8080/callback” is set as the transition-destination URI in the “Location” header. The web browser 51 that has received the message d accesses the “origin_uri” included in the message d received from the transfer server 10 with the group of response parameters. This allows the client 31 to receive the group of response parameters, i.e., the authorization code. An overview of a detailed process flow of OAuth 2.0 will be described below.

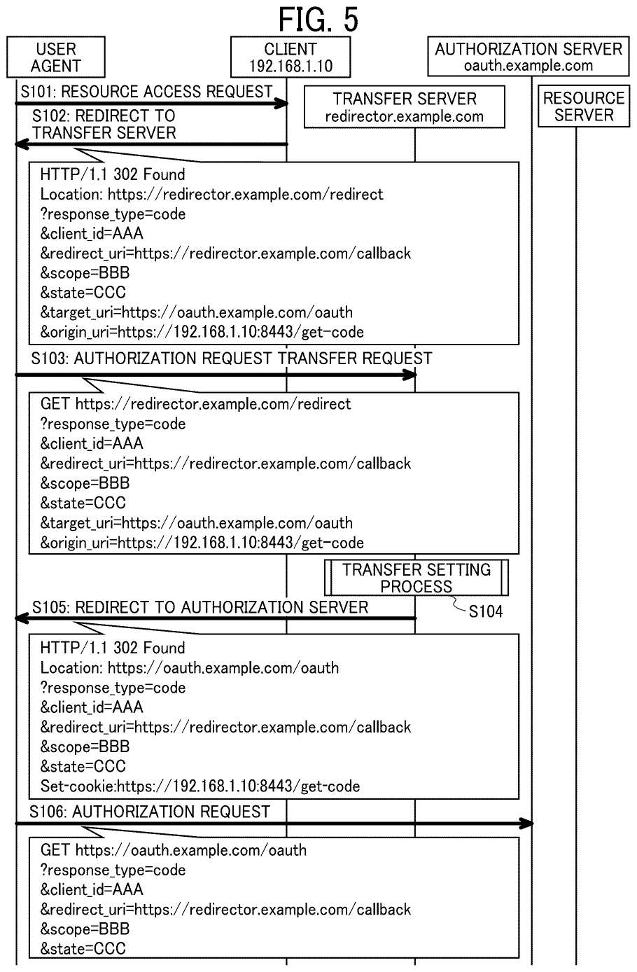

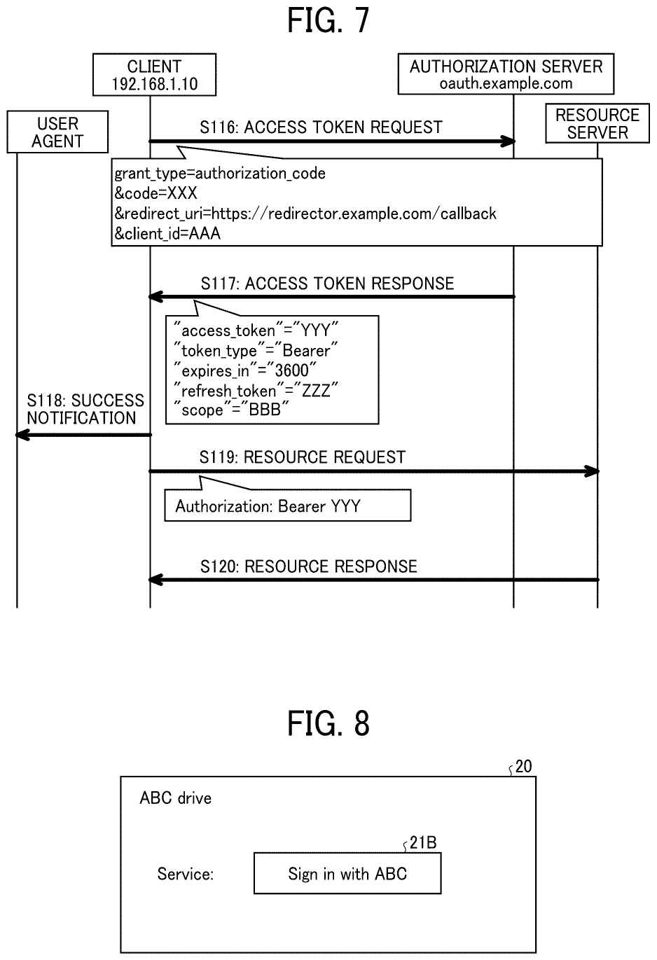

FIGS. 5 to 7 are sequence diagrams illustrating an example of an overview of a communication process flow in OAuth 2.0 according to the present embodiment. The process illustrated in the sequence diagrams starts in response to, for example, a user pressing a link for requesting cooperation with another service (e.g., a service provided by the resource server 70) or a button in which the link is embedded on a page displayed in the web browser 51 of the terminal 50. As preprocessing prior to the process illustrated in the sequence diagrams, a registration process of the client 31 in the authorization server 90 is performed. The authorization server 90 (i.e., the client information holding unit 91) holds the client information (i.e., the client ID, the client secret, and the redirect URI). In the present embodiment, the response transfer path (https://redirector.example.com/callback) of the URI of the transfer server 10 is preregistered as the redirect URI. In the sequence diagrams, a service provided by the resource server 70 is referred to as an “ABC service”, and the client 31 is referred to as an “XYZ application (XYZ app)”. The IP address of the client 31 (i.e., the address of the redirect destination expected by the client) is “192.168.1.10”. The domain of the transfer server 10 is “redirector.example.com”. The domain of the authorization server 90 is “oauth.example.com”.

In step S101, access to a resource (e.g., cooperation with the ABC service) is requested. When the user presses a link (i.e., a link for starting cooperation with the ABC service) on a cooperation request screen (page) displayed on the output device 506 of the terminal 50, the web browser 51 (i.e., user agent) accesses the link and requests the client 31 for service cooperation.

FIG. 8 is a diagram illustrating an example of a cooperation request screen according to the present embodiment. The cooperation request screen is a screen used for requesting cooperation with the ABC service. FIG. 8 illustrates a screen 20 as an example of the cooperation request screen. In the screen 20, a button 21B (i.e., “Sign in with ABC” button) in which a link for requesting cooperation with the ABC service is embedded is arranged (displayed). In response to the user pressing the button 21B, a request for cooperation with the ABC service is made. Thus, an authorization process in OAuth 2.0 starts. The cooperation request screen is not limited to the screen 20 having the configuration illustrated in FIG. 8 since the cooperation request screen is just desired to include a button, a link, or the like for allowing a user to make a cooperation request. The button 21B may be a button displayed as “Cooperate with ABC service”. The process then proceeds to step S102.

In step S102, redirection to the transfer server 10 is performed. The client 31 that has received the request to cooperate with the ABC service in step S101 causes the web browser 51 (user) to access the transfer server 10 (i.e., redirects the web browser 51 to the transfer server 10). Specifically, the client 31 (i.e., the client-side request transmitting unit 32) returns an HTTP message A below to the web browser 51 to redirect the web browser 51 to the transfer server 10.
(Message A)
HTTP/1.1 302 Found Location: https://redirector.example.com/redirect?response_type=code&client_id=AAA&redirect_uri=https://redirector.example.com/callback&scope=BBB&state=CCC&target_uri=https://oauth.example.com/oauth&origin_uri=https://192.168.1.10:8443/get-code

As indicated in the message A, the client 31 sets a URI indicating an authorization request transfer request (hereinafter referred to as an “authorization request transfer request URI”) in the “Location” header. Specifically, the client 31 sets, as the transition destination (i.e., redirect destination) in the “Location” header, the URI of the transfer server 10 (e.g., a combination of the IP address or the host name of the transfer server 10 and a path (e.g., request transfer path)) so that the authorization request transfer request is transmitted to the request transfer path (/redirect) of the transfer server 10. In the “Location” header, the group of request parameters and the transfer parameters are set in a query portion (i.e., a portion after “?” following the transition-destination URI). That is, in the “Location” header, the authorization request transfer request URI including the URI of the transition destination (i.e., the transfer server 10), the group of request parameters, and the transfer parameters is set. The “target_uri” indicates the URI of the authorization server 90 (i.e., authorization endpoint), and corresponds to “https://oauth.example.com/oauth” in the message A. The origin_uri indicates the URI of the redirect destination expected by the client, and corresponds to “https://192.168.1.10:8443/get-code” in the message A. When the client 31 does not designate the authorization server 90 each time, the “target_uri” may be omitted from the transfer parameters. The client 31 provides parameters used for transfer by the transfer server 10 in a format readable by the transfer server 10 and not hindering the process of the authorization server 90.

As indicated in the message A, “https://redirector.example.com/callback”, which is the URI of the transfer server 10 (i.e., the combination of the IP address or the host name of the transfer server 10 and the path (response transfer path)), is set as the redirect URI in the group of request parameters. This redirect URI is requested to be the same as the redirect URI preregistered in the authorization server 90. The group of request parameters includes, as other request parameters related to the authorization request, the client ID, the response type, the state, and the scope. However, the group of request parameters may include any other parameters related to the authorization request.

In the present embodiment, an HTTP status code “302 redirect” is used (returned) to request the web browser 51 for transfer (redirection). Alternatively, “307 Temporary Redirect” may be used. For example, normally, when a request is made by a GET method, a response is made with “302 redirect”. However, when a request is made by a method including content, “307 Temporary Redirect” may be used. In the present embodiment, the client 31 makes a request to the web browser 51 by creating the URI that the web browser 51 is to access and causing the web browser 51 to access the URI. However, the method of making a request to the web browser 51 may be another method depending on an embodiment of the client 31. For example, when the client 31 is a native application, a method based on RFC 8252 (OAuth 2.0 for Native Apps) may be used. After the processing in step S102, the process proceeds to step S103.

In step S103, the authorization request transfer request is made. The web browser 51 accesses the authorization request transfer request URI included in the message received from the client 31 in step S102. Consequently, the web browser 51 sends, to the transfer server 10, an HTTP message B (HTTP request) below.
(Message B)
Get https://redirector.example.com/redirect?response_type=code&client_id=AAA&redirect_uri=https://redirector.example.com/callback&scope=BBB&state=CCC&target_uri=https://oauth.example.com/oauth&origin_uri=https://192.168.1.10: 8443/get-code

As indicated in the message B, the URI included in the message B is the same as the URI included in the message A. The web browser 51 accesses the request transfer path (/redirect) of the transfer server 10 (redirector.example.com) with the group of request parameters and the transfer parameters. This allows the transfer server 10 (a program standing by at https://redirector.example.com/redirect) to receive the group of request parameters and the transfer parameters. After the HTTP message (i.e., authorization request transfer request message) is sent to the transfer server 10 in this manner, the process proceeds to step S104.

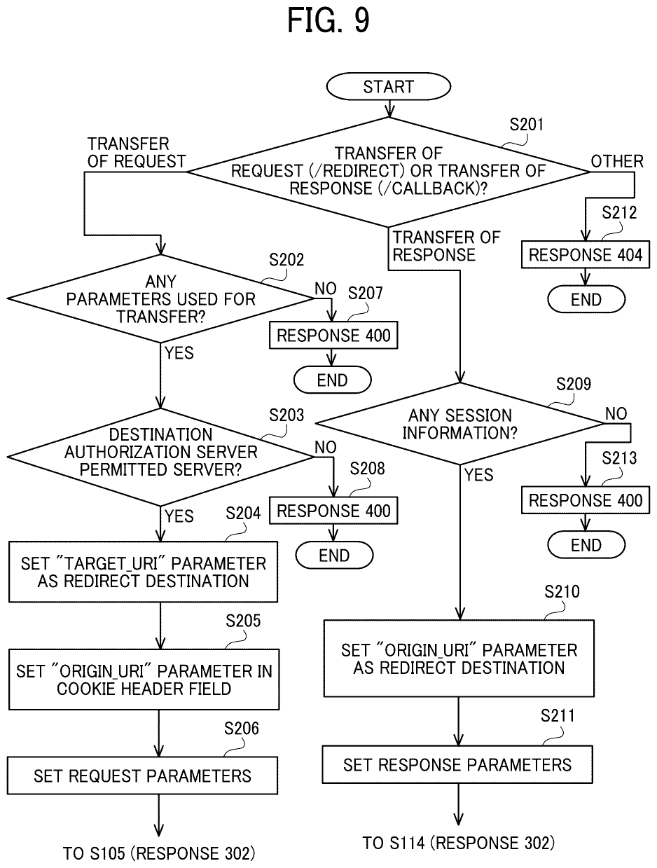

In step S104, a transfer setting process is performed. When the transfer-apparatus-side request receiving unit 11 receives the message transmitted from the web browser 51 in step S103, the transfer server 10 performs various transfer settings (processing of steps S204 to S206 in FIG. 9) because the message is the authorization request transfer request. The transfer setting process will be described below with reference to FIG. 9.

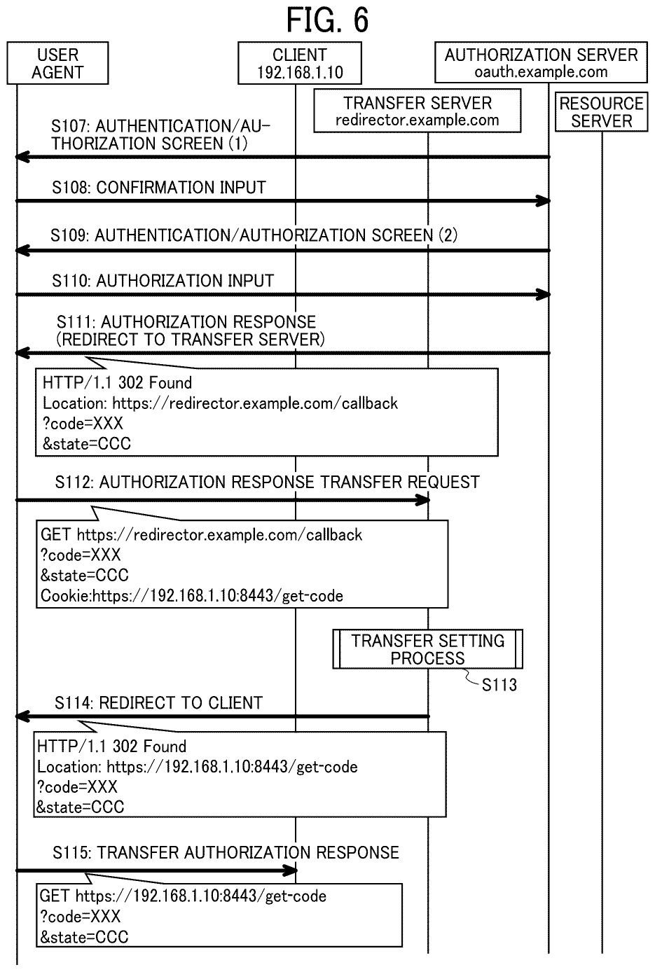

FIG. 9 is a flowchart illustrating an example of an overview of the transfer setting process flow in the transfer server 10 according to the present embodiment. The process illustrated in the flowchart starts in response to, for example, the transfer server 10 receiving a message (e.g., HTTP message) from another apparatus. For example, the process illustrated in the flowchart starts in response to the transfer server 10 receiving the message transmitted in step S103 of FIG. 5 or step S112 of FIG. 6. Hereinafter, in the flowchart, a message triggering the flowchart (e.g., the message transmitted in step S103 or step S112) is referred to as a “received message”.

In step S201, the transfer server 10 determines whether an authorization request is to be transferred or an authorization response is to be transferred. The transfer server 10 (i.e., the transfer-apparatus-side request receiving unit 11) makes the determination with reference to the path (i.e., the access destination) in the URI included in the received message. For example, when the path in the URI included in the received message is “/redirect”, the transfer server 10 determines that transfer of an authorization request is requested. When the path is “/callback”, the transfer server 10 determines that transfer of an authorization response is requested. When transfer of the authorization request is requested (“transfer of request” in step S201), the process proceeds to step S202. When transfer of the authorization response is requested (“transfer of response” in step S201), the process proceeds to step S209. When the path is neither “/redirect” nor “/callback” (“other” in step S201), the process proceeds to step S212. In step S212, the transfer server 10 returns an HTTP 404 error to the web browser 51. The process illustrated in the flowchart and the process illustrated in FIGS. 5 to 7 end. The HTTP 404 error is an error returned when another resource other than transfer is requested. Since a message related to the authorization request transfer request is transmitted in step S103, the process proceeds to step S202 in step S104.

In step S202, the transfer server 10 determines whether there are parameters used for transfer. The transfer server 10 (i.e., the transfer-apparatus-side request receiving unit 11) checks whether the received message includes the parameters used for transfer (“target_uri” and “origin_uri”). As described above, when the client 31 does not designate the authorization server 90 each time, the transfer server 10 just checks whether the received message includes the “origin_uri”. When the message includes the parameters used for transfer (Yes in step S202), the process proceeds to step S203. When the message does not include the parameters used for transfer (No in step S202), the process proceeds to step S207. In step S207, the transfer server 10 returns an HTTP 400 error to the web browser 51. The process illustrated in the flowchart and the process illustrated in FIGS. 5 to 7 end. The HTTP 400 error (bad request) is an error returned when a parameter that cannot be normally transferred is designated.

In step S203, the transfer server 10 determines whether the destination authorization server is a permitted server. First, the transfer server 10 (i.e., the destination information obtaining unit 14) obtains, from the received message, a “target_uri” parameter that is destination information indicating the authorization server 90 requested to perform authorization (i.e., information that designates the authorization server 90 as the destination of the authorization request). Then, the transfer server 10 (i.e., the destination determining unit 15) determines whether the destination indicated by the obtained destination information is an authorization server permitted as the transmission destination of the authorization request. For example, the destination determining unit 15 refers to the permission list held in the transfer server 10 to determine whether the permission list includes the obtained destination information (destination) “https://oauth.example.com/oauth”. By making the determination and restricting the destination, open redirect in which a link disguised as a specific website created by an attacker leads to another dangerous website can be prevented. When the destination is determined to be a permitted server (Yes in step S203), the process proceeds to step S204. When the destination is determined not to be a permitted server (No in step S203), the process proceeds to step S208. In step S208, the transfer server 10 returns the HTTP 400 error to the web browser 51. The process illustrated in the flowchart and the process illustrated in FIGS. 5 to 7 end.

In step S204, the “target_uri” parameter is set as the redirect destination. The transfer server 10 (i.e., the transfer-apparatus-side request transmitting unit 16) sets, as the redirect destination, the “target_uri” parameter “https://oauth.example.com/oauth” obtained in step S203 in the “Location” header field of an HTTP response message to be transmitted to the web browser 51. The process then proceeds to step S205.

In step S205, the “origin_uri” parameter is set in a cookie header field. First, the transfer server 10 (i.e., the transfer destination obtaining unit 12) obtains transfer destination information (i.e., origin_uri) from the received message. Then, the transfer server 10 (i.e., the storage processing executing unit 13) holds (sets) the obtained origin_uri parameter “https://192.168.1.10:8443/get-code” in a cookie header field of the HTTP response message to be transmitted to the web browser 51. This allows the origin_uri parameter to be held (stored) in the cookie of the web browser 51, and allows the transfer server 10 to use the origin_uri held in the cookie when the transfer server 10 receives an authorization response from the authorization server 90. The process then proceeds to step S206.

In step S206, the request parameters (i.e., authorization request parameters) are set. When the URI (i.e., authorization request transfer request URI) included in the received message includes the request parameters, the transfer server 10 (i.e., the transfer-apparatus-side request transmitting unit 16) sets the same values of the request parameters in the “Location” header field of the HTTP response message to be transmitted to the web browser 51. For example, the same values as those of the response type, the client ID, the redirect URI, the scope, and the state included in the received message are set. The process then proceeds to step S105 (response 302) in FIG. 5.

In step S209, the transfer server 10 determines whether there is session information (i.e., cookie information). The transfer server 10 (i.e., the transfer-apparatus-side response receiving unit 17) determines whether the received message includes the cookie information (i.e., “origin_uri” stored in a cookie). When the received message is determined to include the cookie information (Yes in step S209), the response transferring unit 18 obtains the cookie information. The process then proceeds to step S210. When the received message is determined not to include the cookie information (No in step S209), the process proceeds to step S213. In step S213, the transfer server 10 returns the HTTP 400 error to the web browser 51. The process illustrated in the flowchart and the process illustrated in FIGS. 5 to 7 end.

In step S210, the “origin_uri” parameter is set as the redirect destination. The transfer server 10 (i.e., the response transferring unit 18) sets, as the redirect destination, the origin_uri “https://192.168.1.10:8443/get-code” obtained in step S209 in the “Location” header field of the HTTP response message to be transmitted to the web browser 51. The process then proceeds to step S211.

In step S211, the transfer server 10 sets the response parameters (i.e., authorization response parameters). When the URI included in the received message includes the response parameters, the transfer server 10 (i.e., the response transferring unit 18) sets the same values as those of the response parameters in the “Location” header field of the HTTP response message to be transmitted to the web browser 51. For example, the same values are set for the authorization code and the state included in the received message. The process then proceeds to step S114 (response 302) in FIG. 6.

In step S105, a response 302 (i.e., 302 redirection to the authorization server 90) is performed. The transfer server 10 (i.e., the transfer-apparatus-side request transmitting unit 16) returns, to the web browser 51, the HTTP response message (302 redirect) in which various parameters are set in steps S204 to S206 to redirect the web browser 51 to the transition destination (i.e., the authorization server 90) indicated by the “target_uri”. Specifically, an HTTP message C below is returned to the web browser 51.
(Message C)
HTTP/1.1 302 Found Location: https://oauth.example.com/oauth?response_type=code&client_id=AAA&redirect_uri=https://redirector.example.com/callback&scope=BBB&state=CCC Set-cookie: https://192.168.1.10:8443/get-code

As indicated in the message C, the URI indicating the authorization request (hereinafter referred to as an “authorization request URI”) is set in the “Location” header. Specifically, the authorization request URI includes the transition-destination URI (i.e., the combination of the IP address or the host name of the authorization server 90 and the path) and the group of request parameters. Since the “target_uri” and the “origin_uri” are parameters used by the transfer server 10 for transfer, these parameters may be omitted from the authorization request redirected to the authorization server 90. These parameters may be omitted from the message transmitted in step S105. That is, the message transmitted in step S105 includes at least the group of request parameters. After the processing in step S105, the process proceeds to step S106.

In step S106, the web browser 51 makes an authorization request. The web browser 51 accesses the URI (i.e., the authorization request URI) included in the message received from the transfer server 10 in step S105. Consequently, the web browser 51 sends, to the authorization server 90, an HTTP message D (HTTP request) below. Thus, an authorization request is made to the authorization server 90 from the web browser 51.
(Message D)
GET https://oauth.example.com/oauth?response_type=code&client_id=AAA&redirect_uri=https://redirector.example.com/callback&scope=BBB&state=CCC

As indicated in the message D, the URI included in the message D is the same as the URI included in the message C. The web browser 51 accesses the authorization endpoint (oauth.example.com/oauth) of the authorization server 90 with the group of request parameters. This allows the authorization server 90 (a program standing by at oauth.example. com/oauth) to receive the group of request parameters. After the HTTP message (i.e., authorization request message) is sent to the authorization server 90 in this manner, the process proceeds to step S107.

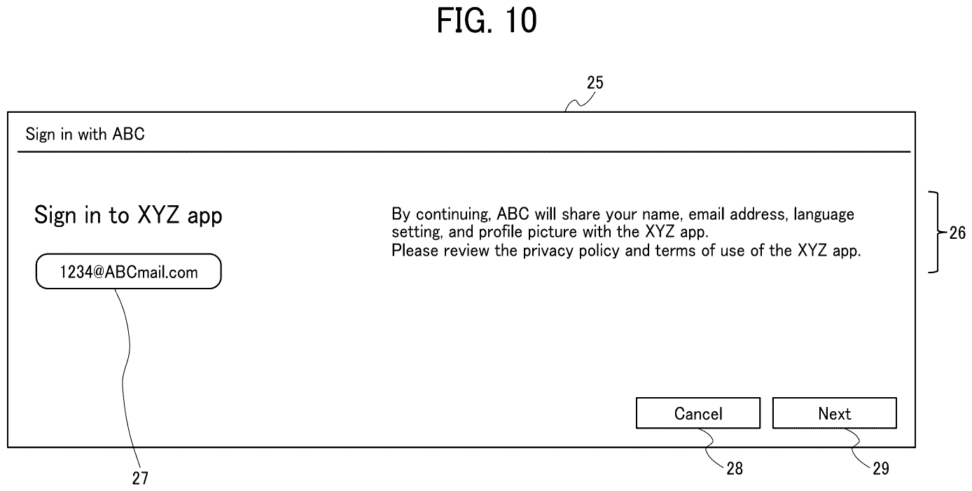

In step S107, an authentication/authorization screen (first page) is transmitted. The authorization server 90 (i.e., the authentication/authorization-server-side request receiving unit 92) that has received the authorization request returns the authentication/authorization screen to the terminal 50 (i.e., the web browser 51). This allows the web browser 51 to display the authentication/authorization screen. In the present embodiment, FIG. 10 illustrates a screen as an example of the authentication/authorization screen (first page).

FIG. 10 is a diagram illustrating an example of the authentication/authorization screen (first page) according to the present embodiment. The authentication/authorization screen is a screen for authenticating a user and obtaining consent (authorization) of the user for giving the client 31 (e.g., XYZ app) an access right to the ABC service. In the authentication/authorization screen, information related to the authorization request (such as information on the client and requested authorities) is displayed. The user checks contents displayed in the authentication/authorization screen and determines whether to approve the authorization request. FIG. 10 illustrates a screen 25 as an example of the authentication/authorization screen to be displayed first (i.e., an authentication/authorization screen of the first page). The screen 25 displays an ABC account (i.e., 1234@ABCmail.com) 27. The user confirms signing in to the XYZ app with the ABC account. Before the authentication/authorization screen illustrated in FIG. 10 is displayed, a screen that allows the user to select a desired account from a plurality of ABC accounts may be displayed. The process then proceeds to step S108.

In step S108, the user inputs confirmation. After the authentication/authorization screen (first page) is displayed in step S107, the user confirms signing in to the XYZ app with the ABC account 27. Specifically, the user confirms that the ABC account 27 displayed in the screen 25 is correct (intended) and confirms confirmation items 26 displayed in the screen 25. After confirming that there is no problem, the user presses a button 29 (“Next” button) (i.e., input confirmation). On the other hand, when the user finds a problem after checking, the user can press a button 28 (“Cancel” button). In response to input by the user, the web browser 51 transmits an input result to the authorization server 90. The process then proceeds to step S109.

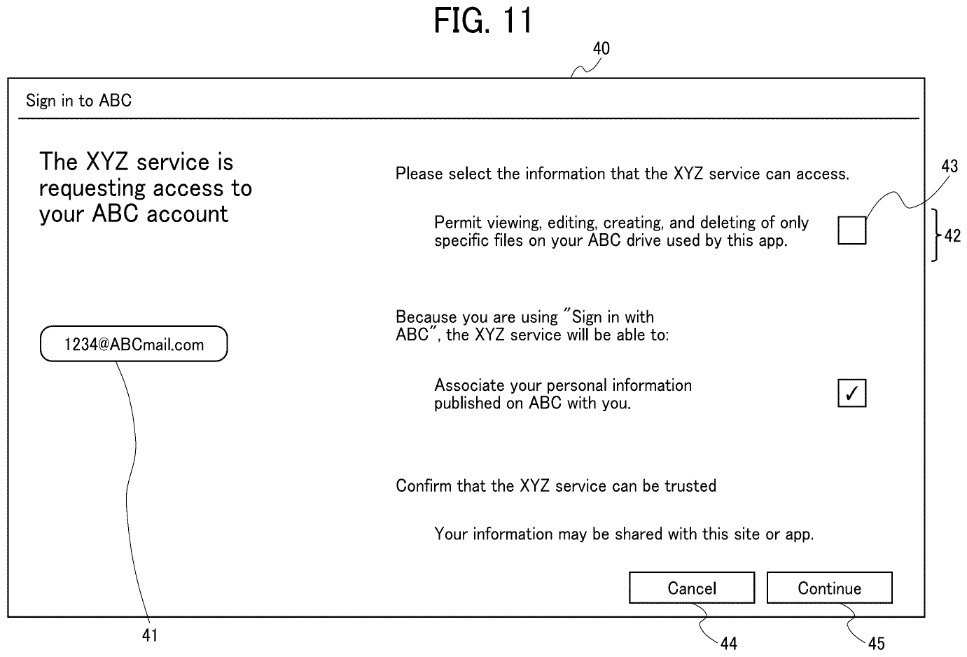

In step S109, an authentication/authorization screen (second page) is transmitted. The authorization server 90 (i.e., the authentication/authorization-server-side request receiving unit 92) that has confirmed pressing of the button 29 by the user in step S108 returns the authentication/authorization screen (second page) to the terminal 50 (i.e., the web browser 51). This allows the web browser 51 to display the authentication/authorization screen (second page). In the present embodiment, FIG. 11 illustrates a screen as an example of the authentication/authorization screen (second page).

FIG. 11 is a diagram illustrating an example of the authentication/authorization screen (second page) according to the present embodiment. FIG. 11 illustrates a screen 40 as an example of the authentication/authorization screen (second page). The screen 40 displays an ABC account (i.e., 1234@ABCmail.com) 41. The screen 40 also displays a message 42 regarding an access right “Permit viewing, editing, creating, and deleting of only specific files on your ABC drive used by this app”, and a checkbox 43 allowing the user to input confirmation of the message 42. The authentication/authorization screen is not limited to the screens having the configuration illustrated in FIGS. 10 and 11 and may be any screen that allows authentication of a user and acquisition of authorization for an access right. For example, the screens illustrated in FIGS. 10 and 11 may have a configuration allowing the user to input a login ID and a password of the ABC account. Any method other than a method using the ID and the password may be used for user authentication. For example, instead of performing user authentication and authorization for an access right using multiple screens as in FIGS. 10 and 11, the screens illustrated in FIGS. 10 and 11 may be combined into one screen. The number of interactions (i.e., the number of displayed screens) between the authorization server 90 and the web browser 51 for user authentication and authorization for an access right may be optional. The process then proceeds to step S110.

In step S110, authorization input is performed. After the authentication/authorization screen (second page) is displayed in step S109, the user confirms whether there is no problem with the message 42 regarding an access right and other confirmation items, checks the checkbox 43, and presses a button 45 (“Continue” button) (i.e., input authorization). On the other hand, when the user finds a problem after the check, the user can press a button 44 (“Cancel” button). In response to input by the user, the web browser 51 transmits an input result to the authorization server 90. The process then proceeds to step S111.

In step S111, an authorization response (redirection to the transfer server 10) is performed. When the user authentication and authorization process is performed successfully in steps S107 to S110, the authorization server 90 (i.e., the response transmitting unit 93) returns an authorization response including an authorization code to the web browser 51 to redirect the web browser 51 to the transfer server 10. Specifically, the authorization server 90 (i.e., the response transmitting unit 93) returns an HTTP message E below to the web browser 51. The message E causes redirection using an HTTP status code “302”. However, redirection may be performed using another HTTP status code (e.g., “307”).
(Message E)
http/1.1 302 found location: https://redirector.example.com/callback?code=XXX&state=CCC

As indicated in the message E, the authorization server 90 (i.e., the response transmitting unit 93) sets the URI indicating an authorization response (hereinafter referred to as an “authorization response URI”) in the “Location” header. Specifically, in the “Location” header, the redirect URI (i.e., the URI of the transfer server 10) included in the authorization request message received in step S106, that is, the redirect URI preregistered for the client 31, is set as the transition destination. In the query portion of the “Location” header, the group of response parameters is set. The group of response parameters includes at least an authorization code “XXX” generated by the authorization server 90. The value of the “Location” header of the authorization response includes the transition destination and the group of response parameters. After the processing in step S111, the process proceeds to step S112.

In step S112, an authorization response transfer request is made. The web browser 51 accesses the URI (i.e., authorization response URI) included in the message received from the authorization server 90 in step S111. That is, the web browser 51 transitions to a location indicated by the “Location” header (i.e., the URI of the transfer server 10). Consequently, the web browser 51 sends, to the transfer server 10, an HTTP message F (HTTP request) below. As indicated in the message F, the web browser 51 returns, to the transfer server 10, information (i.e., “origin_uri”) held in the cookie in response to an instruction of the transfer server 10.
(Message F)
GET https://redirector.example.com/callback?code=XXX&state=CCC Cookie: https://192.168.1.10:8443/get-code

As indicated in the message F, the URI included in the message F is the same as the URI included in the message E. The web browser 51 accesses the response transfer path (/callback) of the transfer server 10 (redirector.example.com) with the group of response parameters. This allows the transfer server 10 (a program standing by at https://redirector. example.com/callback) to receive the group of response parameters. After the HTTP message (i.e., authorization response transfer request message) is sent to the transfer server 10 in this manner, the process proceeds to step S113.

In step S113, the transfer setting process illustrated in FIG. 9 is performed. When the transfer-apparatus-side response receiving unit 17 receives the message transmitted from the web browser 51 in step S112, the transfer server 10 performs various transfer settings (i.e., processing of steps S210 and S211 in FIG. 9) because the message is the authorization response transfer request. The process then proceeds to step S114.

In step S114, the response 302 (i.e., 302 redirection to the client 31) is performed. The transfer server 10 (i.e., the response transferring unit 18) returns, to the web browser 51, an HTTP response message (302 redirect) in which various parameters are set in steps S210 and S211 to redirect the web browser 51 to the transition destination (i.e., the client 31) indicated by the “origin_uri”. Specifically, an HTTP message G below is returned to the web browser 51.
(Message G)
HTTP/1.1 302 Found Location: https://192.168.1.10:8443/get-code?code=XXX&state=CCC

As indicated in the message G, in the “Location” header, the URI including the transition-destination URI (i.e., the combination of the IP address or the host name of the client 31 serving as the transfer destination and the path) and the group of response parameters is set. After the processing in step S114, the process proceeds to step S115.

In step S115, the authorization response is transferred. The web browser 51 accesses the URI included in the message received from the transfer server 10 in step S114 (i.e., the URI set in the “Location” header). Consequently, the web browser 51 sends, to the client 31, an HTTP message H (HTTP request) below.
(Message H)
GET https://192.168.1.10:8443/get-code?code=XXX&state=CCC

As indicated in the message H, the URI included in the message H is the same as the URI included in the message G. The web browser 51 accesses the URI of the client 31 with the group of response parameters. This allows the client 31 (i.e., the client-side response receiving unit 33) to receive the group of response parameters, that is, the authorization code. After the HTTP message (i.e., the authorization response transfer message) is sent to the client 31 in this manner, the process proceeds to step S116.

In step S116, an access token is requested. The client 31 (i.e., the client-side request transmitting unit 32) uses the authorization code obtained in step S115 to send a token request (i.e., a request for an access token) to the token endpoint of the authorization server 90. Specifically, an HTTP message (i.e., POST request message) including a group of parameters I below is sent to the authorization server 90.
(Group of parameters I)
grant_type=authorization_code&code=XXX&redirect_uri=https://redirector.example.com/callback&client_id=AAA

As indicated in the group of parameters I, the token request message includes parameters such as the authorization code, the redirect URI, and the client ID. When the redirect URI parameter is designated in the authorization request, a redirect URI parameter having the same value is also designated in the token request. Depending on the type of the client 31, the group of parameters I may include the client secret. The process then proceeds to step S117.

In step S117, an access token response is made. The authorization server 90 (i.e., the response transmitting unit 93) generates an access token and returns the access token to the client 31. Specifically, an HTTP message including a group of parameters J below is returned to the client 31. This allows the client 31 (i.e., the client-side response receiving unit 33) to obtain the access token from the authorization server 90.
(Group of parameters J)
“access_token”:“YYY”,“token_type”:“Bearer”,“expires_in”=“3600”,“refresh_token”=“ZZZ”,“ scope”=“BBB”

As indicated in the group of parameters J, the access token response includes parameters such as “access_token” (access token) “YYY”, “token_type” (token type), “expires_in” (valid seconds), “refresh_token” (refresh token), and “scope”. The refresh token is a token for obtaining a new access token without the user signing in again even after the access token expires. The process then proceeds to step S118.

In step S118, a success notification is made. The client 31 makes a success notification (i.e., a notification that access to the resource is permitted) to the web browser 51. For example, the client 31 transmits, to the web browser 51, a page (i.e., success notification screen) for making the success notification to make the success notification.

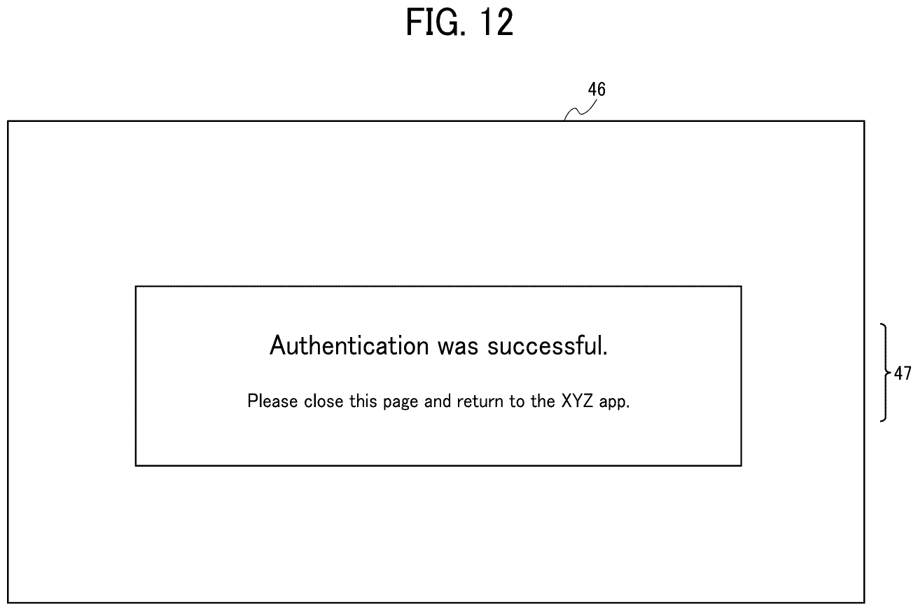

FIG. 12 is a diagram illustrating an example of the success notification screen according to the present embodiment. FIG. 12 illustrates a screen 46 as an example of the success notification screen. The screen 46 displays a success notification message 47 (“Authentication was successful. Please close this page and return to the XYZ app.”). Contents of the success notification message 47 are not limited to the message contents illustrated in FIG. 12, and the success notification message 47 may be any message. In step S118, the client 31 makes the success notification in response to the access token being successfully obtained. However, the client 31 may make the success notification in response to successful receipt of a resource response from the resource server 70 (confirmation of successful access to the resource server 70). That is, the success notification may be made after processing of step S120. The success notification may be omitted. The process then proceeds to step S119.

In step S119, a resource request is made. The client 31 (i.e., the client-side request transmitting unit 32) presents, to the resource server 70, the access token (“YYY”) obtained in step S117 to request a resource. Accordingly, the resource server 70 (i.e., the resource request receiving unit 71) receives the resource request including the access token. The process then proceeds to step S120.

In step S120, a resource response is made. The resource server 70 (i.e., the resource response unit 72) that has verified the validity of the access token presented in step S119 returns the requested resource to the client 31 to make the resource response. Accordingly, cooperation among services is performed. The process illustrated in the sequence diagrams then ends.

In the present embodiment, the transfer destination (origin_uri) of the group of response parameters is set by the URI of the client 31. However, the transfer destination does not have to be the client 31. When the transfer destination is another program (application) other than the client 31, the other program may deliver the received group of response parameters to the client 31 by some method to allow the client 31 to use, for example, the group of response parameters (authorization code). In the present embodiment, the example is presented in which the transfer destination information (origin_uri) is held in the cookie of the web browser 51. However, the transfer destination information may be held (managed) by another method. For example, after obtaining the transfer destination information, the transfer server 10 may store, in the storage device 104 of the transfer server 10 or an external apparatus accessible by the transfer server 10, the transfer destination information in association with information that enables identification of a session or the IP address of the user agent. This allows the transfer server 10 to read and use the transfer destination information based on information that enables, for example, identification of a session or the IP address. As the information that enables identification of a session, for example, a session ID or the “state” parameter in OAuth 2.0 can be used. The transfer destination information may be included in an authentication/authorization request as the URI parameter, and an authentication/authorization server that has received the authentication/authorization request may include the transfer destination information in an authorization response as the URI parameter to allow the transfer server 10 to obtain the transfer destination information from the authentication/authorization server via the user agent. As described in the second variation below, the transfer destination information may be included in a request body using a POST method and presented (transmitted) to the transfer server 10.

As described above, according to the present embodiment, the transfer server 10 that has received response parameters from the authorization server 90 transfers the response parameters to a transfer destination indicated by transfer destination information that designates a transfer destination of the response parameters (i.e., a destination expected by the client). This allows the response parameters related to authentication or authorization to be transmitted (transferred) to the destination expected by the client. That is, the transfer server 10 is provided between the user agent (i.e., the web browser 51) and the authorization server 90 and the transfer server 10 serves as a representative URI (redirect URI) and receive and mediate the response parameters from the authorization server 90. This allows the response parameters to be transferred (retransferred) to the URI expected by each client. Accordingly, even when the address of the destination expected by the client (e.g., the address of the client) as viewed from the user agent dynamically changes due to, for example, a network environment, the response parameters can be transferred to the destination expected by the client. That is, even when the address of the destination expected by the client changes, the response parameters can be transmitted to the destination expected by the client. For example, in a case where an access token is to be obtained for transferring a file directly from an application (client) operating on a scanner to a server (resource server) providing a cloud storage service, even when the URI of the client as viewed from the user agent changes, the authorization code can be delivered to the client.

According to the present embodiment, by configuring an intermediate transfer function (transfer server), the existing processing of existing authorization servers can be kept unchanged unlike the authority transfer system disclosed in JP-A-2019-046060. Even when an external existing authorization server (third-party authorization server) and a terminal browser are used, a dynamic client (a client whose address may dynamically change) can be handled. The transfer function of the present embodiment can maintain communication between authorization parties by redirection to the terminal browser without proxying communication. Thus, a security extension (Proof Key for Code Exchange by OAuth Public Clients (PKCE)) that authenticates a requester by challenge-response can be supported.

According to the processes in the present embodiment, one client identifier (i.e., the client ID and the client secret) can be shared among multiple forms.

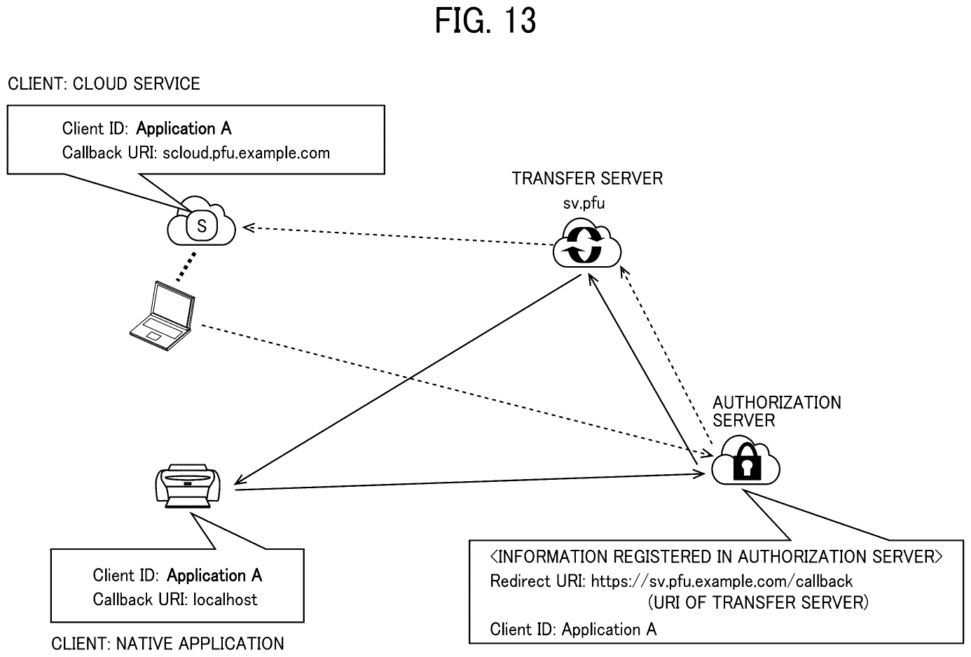

FIG. 13 is a diagram illustrating an example of a case of sharing the client identifier according to the present embodiment. FIG. 13 illustrates a case where a web service (cloud service) having an Internet address and a native client (native application) having a local address use the same client ID “Application A”. That is, FIG. 13 illustrates the web service and the native client as an example of the multiple forms. As a callback URI of the web service (i.e., the transition destination expected by the client), “scloud.pfu.example.com” is exemplified. As a callback URI of the native client, “localhost” is exemplified. In such a case, since the transition destinations (callback URIs) expected by respective forms (applications) differ, multiple redirect URIs are usually to be registered in the authorization server for the same client ID in OAuth 2.0. However, depending on the implementation of the authorization server, registration of multiple redirect URIs for the same client ID is not permitted. In this case, even when the web service and the native client are implemented as one service, the web service and the native client are to be separated by multiple client identifiers as different clients for the respective forms.

However, in the present embodiment, even in such a case, the use of the URI of the transfer server “https://sv.pfu.example.com/callback” as the redirect URI for the client ID “Application A” allows one client identifier to be shared among multiple forms. Specifically, after the transfer server 10 receives the authorization code for the client ID “Application A”, the transfer server 10 transfers the authorization code to the callback URI (origin_uri) expected by each form. This enables the authorization code to be obtained at the redirect destination expected by the client even when the client ID is shared among multiple forms.

### First Variation

In the embodiment described above, the group of request parameters included in the authorization request includes the redirect URI parameter as a request parameter. Alternatively, the authorization request may include, instead of the redirect URI itself, a “request” parameter or a “request_uri” parameter defined in RFC 9101, which is a document (technical specification) related to an OAuth 2.0 authorization framework “JWT-Secured Authorization Request (JAR)”. In the present variation, an example case will be described where the authorization request includes the “request” parameter or the “request_uri” parameter, instead of the redirect URI itself. In the description of the present variation below, the description of the configuration common to the above-described embodiment is omitted, and differences from the above-described embodiment will be described. A configuration of a system according to the present variation is substantially the same as the system configuration illustrated in FIG. 1, and the description thereof is omitted. A functional configuration of the system according to the present variation is substantially the same as the functional configuration of the system illustrated in FIG. 2, and the description thereof is omitted. Differences from the contents described in the above embodiment will be described below.

JAR defines a method for combining multiple request parameters related to an authorization request into one JWT. JAR allows an authorization request to include a JWT as the value of the “request” parameter or a URI (i.e., a reference to the JWT) referring to the JWT as the value of the “request_uri” parameter, instead of enumerating individual request parameters. A JWT is called a request object and holds a group of JSON-encoded parameters. Hereinafter, the request parameters included in the JWT are referred to as a “group of JWT parameters”.

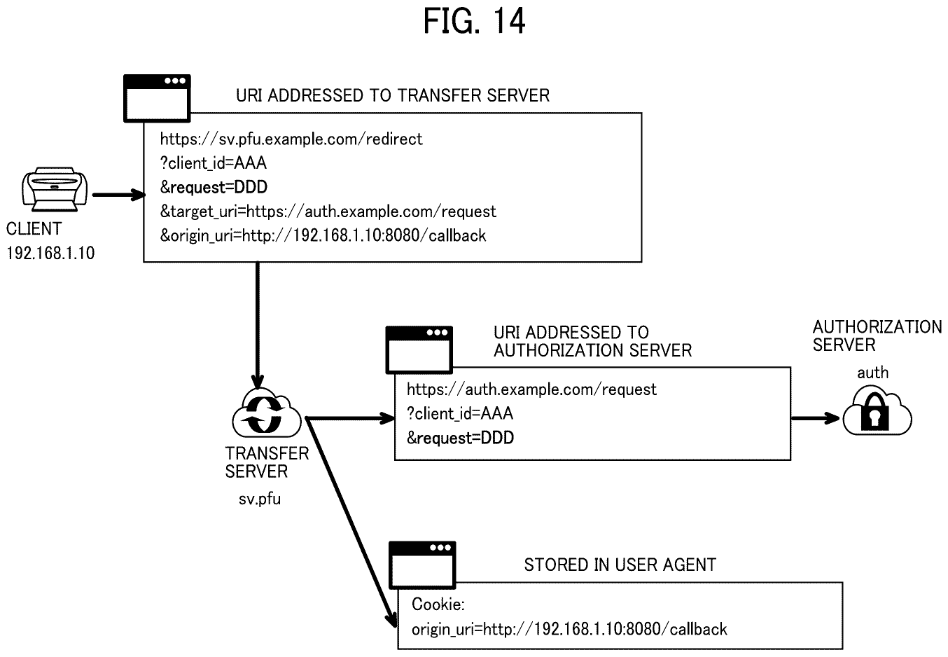

FIG. 14 is a diagram illustrating an example of an overview of the authorization request (including the “request” parameter) in OAuth 2.0 according to the present variation. Parameters used similarly to those in the overview of the authorization request in OAuth 2.0 according to the embodiment described above (FIG. 3) are the same as those described in the above embodiment, and the description thereof is omitted. Differences from the overview of the authorization request illustrated in FIG. 3 will be described below. As illustrated in FIG. 14, when the “request” parameter is used, the client 31 (i.e., the client-side request transmitting unit 32) sets the “request” parameter (i.e., “request=DDD”) in the group of request parameters included in the authorization request. A request object indicated by “DDD” includes, for example, the group of JWT parameters such as the response type, the redirect URI, the scope, and the state illustrated in FIG. 3. The request object may be created by the client 31 (i.e., the client apparatus 30) or may be created by another apparatus. In the transfer server 10 that has received the group of request parameters (i.e., a request message) from the client 31 via the web browser 51, the transfer-apparatus-side request transmitting unit 16 rewrites the redirect destination as in the case of FIG. 3, and instructs the web browser 51 to transmit the authorization request including the “request” parameter to the authorization server 90. The authorization server 90 (i.e., the authentication/authorization-server-side request receiving unit 92) that has received the authorization request from the web browser 51 obtains the “request” parameter (request object) and can obtain the group of JWT parameters such as the redirect URI. When the request object is encrypted, the authorization server 90 decrypts the request object and can obtain the group of JWT parameters. The transfer server 10 (i.e., the storage processing executing unit 13) manages a session of the “origin_uri” as in FIG. 3.

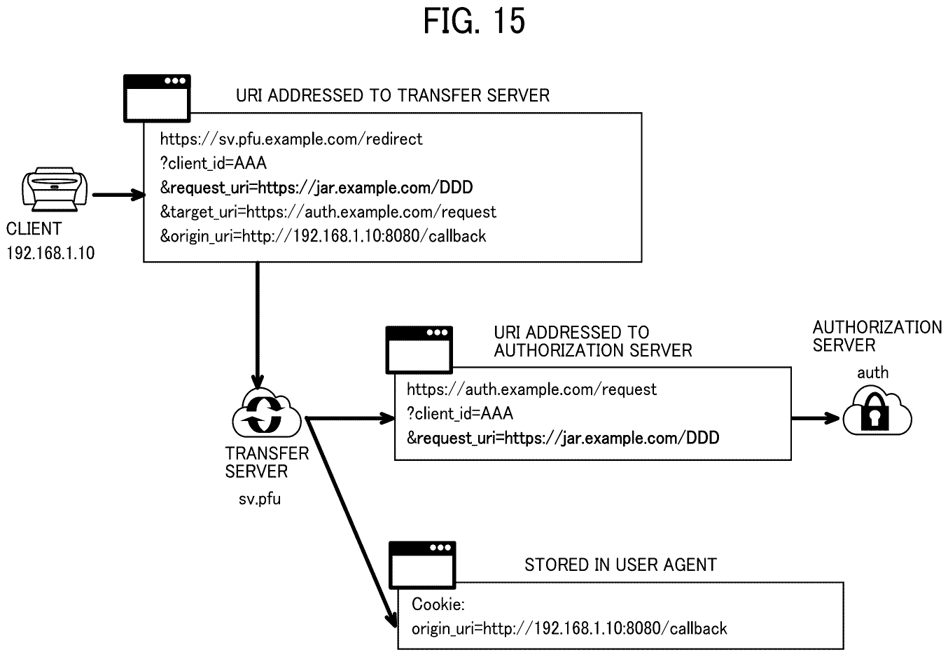

FIG. 15 is a diagram illustrating an example of an overview of an authorization request (including the “request_uri” parameter) in OAuth 2.0 according to the present variation. Similarly to FIG. 14, differences from the overview of the authorization request illustrated in FIG. 3 will be described. As illustrated in FIG. 15, when the “request_uri” parameter is used, the client 31 (i.e., the client-side request transmitting unit 32) sets a “request_uri” parameter (“request_uri=https://jar.example.com/DDD”) in the group of request parameters included in the authorization request. “request_uri=https://jar.example.com/DDD” is a URI indicating a reference (location) of the request object indicated by “DDD” described with reference to FIG. 14. The location where “DDD” is deployed may be the client apparatus 30 or may be another server. In the transfer server 10 that has received the group of request parameters (i.e., a request message) from the client 31 via the web browser 51, the transfer-apparatus-side request transmitting unit 16 rewrites the redirect destination as in the case of FIG. 3, and instructs the web browser 51 to transmit the authorization request including the “request_uri” parameter to the authorization server 90. The authorization server 90 (i.e., the authentication/authorization-server-side request receiving unit 92) that has received the authorization request from the web browser 51 accesses the URI indicated by the “request_uri” parameter to obtain the request object “DDD”. This allows the authorization server 90 to obtain the group of JWT parameters such as the redirect URI. When the request object is encrypted, the authorization server 90 decrypts the request object and can obtain the group of JWT parameters. The transfer server 10 manages a session of the “origin_uri” as in FIG. 3. The case illustrated in FIG. 15 includes the case of RFC 9126 (Pushed Authorization Requests) in which an authorization request is made using a request_uri issued by the authorization server 90 by preregistering request parameters from the client 31 to the authorization server 90 by a POST message.

As described above, even when the “request” parameter or the “request_uri” parameter is used, the transfer server 10 that has obtained the group of response parameters transmitted from the authorization server 90 can perform the transfer process of the group of response parameters as in the above embodiment. The same advantageous effects as those of the above embodiment can be achieved. An overview of an authorization response in response to the authorization requests illustrated in FIGS. 14 and 15 is substantially the same as the overview of the authorization response illustrated in FIG. 4, and the description thereof is omitted.

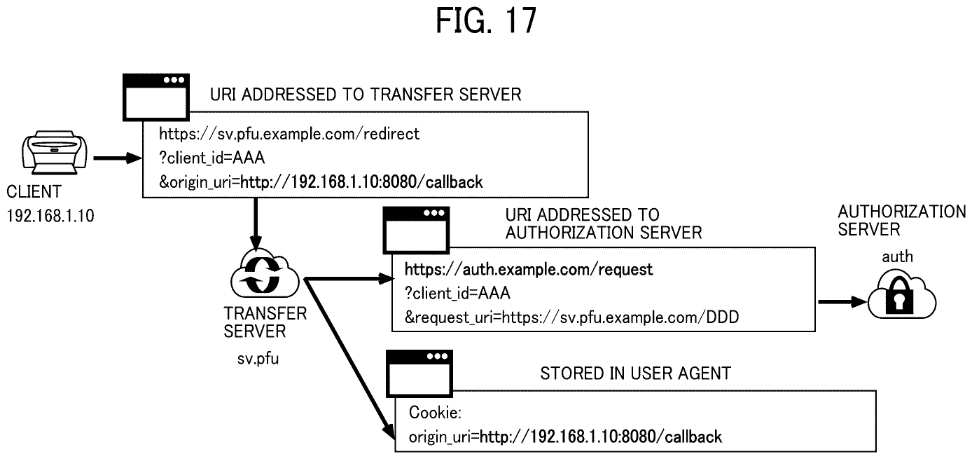

FIG. 15 illustrates an example case where the client 31 delivers the “request_uri” parameter to the transfer server 10. However, the transfer server 10 may issue (distribute) the “request_uri” parameter. For example, the transfer server 10 may receive information corresponding to a JWT (i.e., the request parameters) in advance from the client 31. The transfer server 10 may generate a JWT including only parameters to be used, and issue a reference to the JWT to the authorization server 90. An example case where the transfer server 10 issues a reference to a JWT will be described below with reference to FIGS. 16 and 17.

FIG. 16 is a diagram illustrating an example of an overview of an authorization request (a first request message) in OAuth 2.0 according to the present variation. As illustrated in FIG. 16, a request message e for an authorization request, which is an HTTP message (POST message) below, is transmitted from the client 31 (i.e., the client-side request transmitting unit 32) to the transfer server 10. The transfer server 10 (i.e., the transfer-apparatus-side request receiving unit 11) receives the request message e from the client 31. Consequently, the group of request parameters (e.g., the response type, the client ID, the state, the redirect URI, the client assertion type, the client assertion) and the transfer parameters (e.g., “target_uri”) are preregistered in the transfer server 10.
(Message e)
POST/as/par HTTP/1.1 Host: sv.pfu.example.com Content-Type: application/x-www-form-urlencoded &response_type=code&client_id=AAA&state=CCC&redirect_uri=https://sv.pfu.example.com/callback&client_assertion_type=EEE&client_assertion=FFF&target_uri=https://auth.example.com/request

The message e is referred to as a “first request message” transmitted from the client 31. The transfer server 10 (i.e., the transfer-apparatus-side request receiving unit 11) receives the message e to receive the various parameters. The transfer server 10 (i.e., the transfer-apparatus-side request transmitting unit 16) then selects parameters to be presented to the authorization server 90 out of the information obtained from the client 31, and generates a JWT in which the selected parameters are collectively encoded. For example, since the “target_uri” parameter is not to be included in the JWT (presented to the authorization server 90), the “target_uri” parameter can be omitted from the JWT. The transfer server 10 (i.e., the transfer-apparatus-side request transmitting unit 16) generates, for example, a JWT including the response type, the state, and the redirect URI. The transfer server 10 then stores the generated JWT in the transfer server 10 or another apparatus accessible by the transfer server 10, issues a reference (URI) to the storage location, and returns, to the client 31, an HTTP message f below including the reference as the “request_uri” parameter.
(Message f)
HTTP/1.1 201 Created Cache-Control: no-cache, no-store Content-Type: application/json{“request_uri”:“https://sv.pfu.example.com/DDD”“expires_in”: 90}

The message f includes the “request_uri” parameter. However, when the transfer server 10 can manage a session of the “request_uri” parameter in association with the client 31 (i.e., the first request message), the transfer server 10 can read the corresponding “request_uri” parameter upon receiving a second request message from the client 31, and include the “request_uri” parameter in the group of request parameters. In such a case, the message f may omit the “request_uri” parameter.

FIG. 17 is a diagram illustrating an example of an overview of an authorization request (a second request message) in OAuth 2.0 according to the present variation. As illustrated in FIG. 17, the client 31 (i.e., the client-side request transmitting unit 32) transmits an authorization request transfer request (i.e., the second request message) to the transfer server 10 via the web browser 51. Specifically, the client 31 instructs the web browser 51 to transmit an HTTP message g below to the transfer server 10. The transfer server 10 (i.e., the transfer-apparatus-side request receiving unit 11) receives the second request message from the web browser 51.
(Message g)
GET https://sv.pfu.example.com/redirect?client_id=AAA&origin_uri=http://192.168.1.10:8080/callback

The URI included in the message g includes the request parameters (e.g., “client_id”) and the transfer parameters (e.g., “origin_uri”). The transfer server 10 can receive to-be-used information (parameters) from the client 31 in two stages. In the transfer server 10 that has received the message g, the transfer-apparatus-side request transmitting unit 16 rewrites the redirect destination of the message g and adds the “request_uri” parameter as a request parameter, and performs redirection. Specifically, the transfer server 10 transmits, to the web browser 51, an HTTP message h below in which the “target_uri” included in the message e is set as the redirect destination and the “request_uri” parameter is added as the request parameter, to redirect the web browser 51 to the authorization server 90. The transfer server 10 also manages a session of the “origin_uri” included in the message g.
(Message h)
HTTP/1.1 302 Found Location: https://auth.example.com/request?client_id=AAA?request_uri=https://sv.pfu.example.com/DDD

The web browser 51 that has received the message h accesses the endpoint of the authorization server 90 with the group of request parameters. This allows the authorization server 90 to receive the authorization request. The examples of FIGS. 16 and 17 present the example case where a JWT including only the request parameters included in the first request message is created. However, the JWT may include the request parameters included in the second request message. In this case, the transfer server 10 may generate the JWT after receiving the second request message. The parameters transmitted in the first request message and the parameters transmitted in the second request message are not limited to the examples illustrated in FIGS. 16 and 17. For example, the origin_uri parameter may be transmitted in the first request message, or for example, the target_uri may be transmitted in the second request message. When the client 31 can receive the “request_uri” parameter in the message f, the client 31 may include the “request_uri” parameter in the message g.

In the method illustrated in FIGS. 16 and 17, since the “request_uri” parameter is set as the URI to be transmitted from the transfer server 10 to the authorization server 90, the authorization server 90 performs processing in accordance with RFC 9101. That is, even when the method illustrated in the first variation is used, a dynamic client can be handled in the authentication/authorization process performed using existing authentication/authorization servers. The transfer server 10 may receive a JWT from the client 31 by the method illustrated in FIG. 14 (i.e., the method using the “request” parameter), store the JWT in the transfer server 10 or an apparatus accessible by the transfer server 10, and then issue a reference to the JWT.

### Second Variation

In the present variation, a case where redirection in the embodiment described above is terminated once will be described. In the description of the present variation below, the description of the configuration common to the above-described embodiment is omitted, and differences from the above-described embodiment will be described. A configuration of a system according to the present variation is substantially the same as the system configuration illustrated in FIG. 1, and the description thereof is omitted. A functional configuration of the system according to the present variation is substantially the same as the functional configuration of the system illustrated in FIG. 2, and the description thereof is omitted. Differences from the contents described in the above embodiment will be described below.

A process flow in the present variation will be described based on comparison with the process flow in the above embodiment. First, the process flow in the above embodiment will be described.

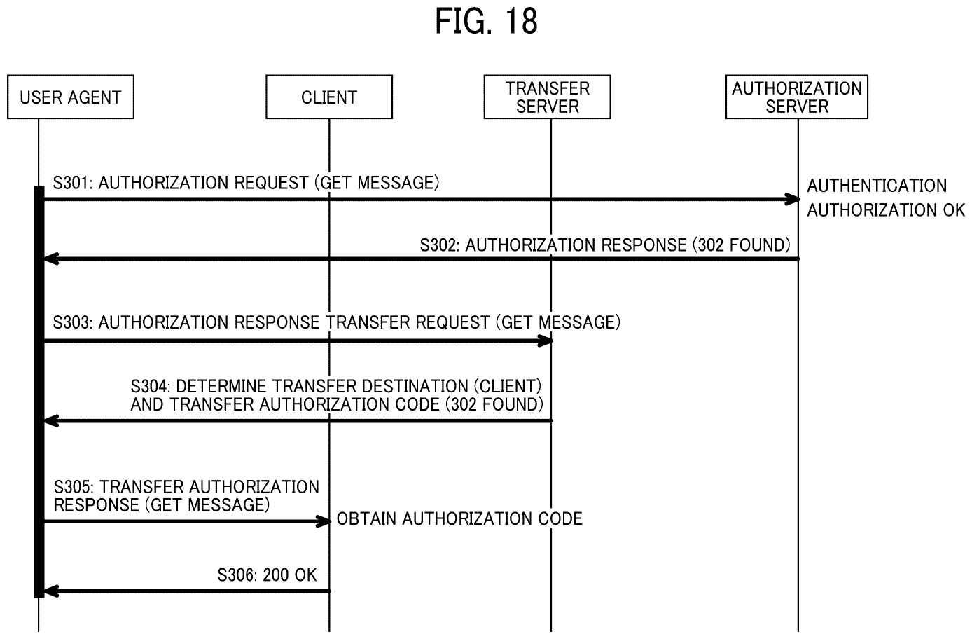

FIG. 18 is a sequence diagram illustrating an example of an overview of a communication process flow (after user authentication by the authorization server 90) in OAuth 2.0 according to the above-described embodiment. The process illustrated in this sequence diagram starts in response to the processing performed in step S105 in FIG. 5. In response to an authorization request to the authorization server 90 in step S301, the authorization server 90 performs an authentication/authorization process. Since the processing of step S301 is substantially the same as the processing of step S106 in FIG. 5 and the authentication/authorization process performed by the authorization server 90 is the same as the processing of steps S107 to S110 in FIG. 6, detailed description thereof is omitted. The authorization server 90 makes an authorization response in step S302. The user agent transmits an authorization response transfer request to the transfer server 10 in step S303. The transfer server 10 determines the transfer destination (i.e., the client 31) based on the cookie information obtained from the user agent (i.e., the cookie information held in the user agent in step S105 of FIG. 5) and transfers the authorization code in step S304. The user agent transfers the authorization response to the client 31 in step S305. The client 31 makes, to the user agent, a response (200 OK response) notifying the user agent that the request is successful in step S306. Since the processing of steps S302, S303, S304, and S305 is the same as the processing of steps S111, S112, S113, S114, and S115 in FIG. 6, detailed description thereof is omitted.

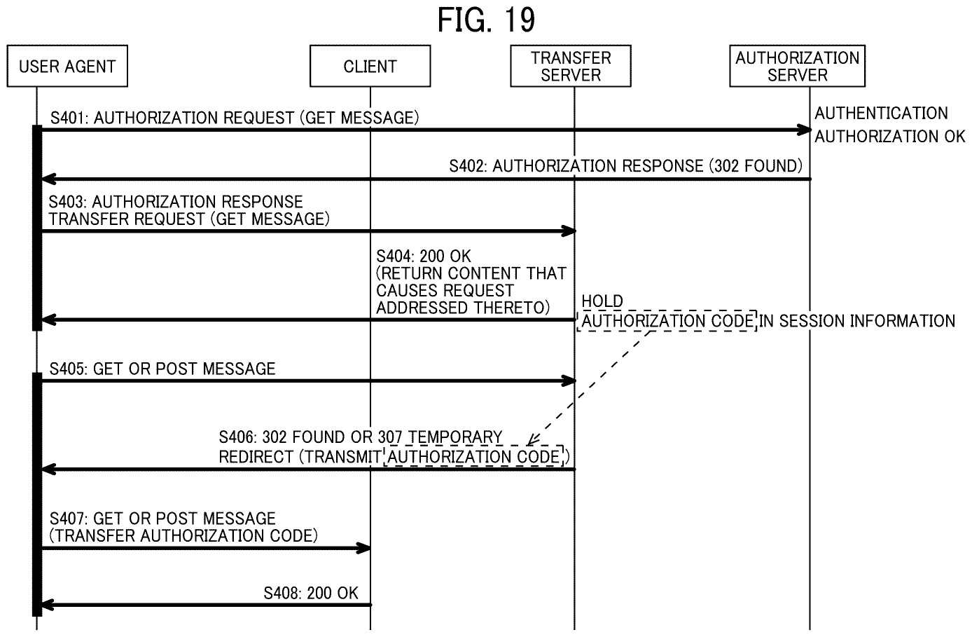

FIG. 19 is a sequence diagram illustrating an example of an overview of a communication process flow (after user authentication by the authorization server 90) in OAuth 2.0 according to the present variation. The process illustrated in this sequence diagram starts in response to the processing performed in step S105 in FIG. 5. In the present variation, presentation of the transfer destination information from the client 31 to the user agent in step S102 may be omitted. When the transfer destination information is not presented in step S102, an instruction to hold the cookie information (“origin_uri”) is not given to the user agent in step S105.

In response to an authorization request to the authorization server 90 in step S401, the authorization server 90 performs an authentication/authorization process. Since the processing of step S401 is substantially the same as the processing of step S106 in FIG. 5 and the authentication/authorization process performed by the authorization server 90 is the same as the processing of steps S107 to S110 in FIG. 6, detailed description thereof is omitted. The authorization server 90 makes an authorization response in step S402. The user agent transmits an authorization response transfer request to the transfer server 10 in step S403. The transfer server 10 (i.e., the response transferring unit 18) makes, to the user agent, a response notifying the user agent that the request is successful in step S404. Accordingly, the redirection is terminated once at the transfer server 10. In step S404, the transfer server 10 returns, to the user agent, content that causes a request addressed to the transfer server 10. For example, the transfer server 10 (i.e., the response transferring unit 18) creates content A below using a meta fresh addressed to the transfer server 10, and returns the content A to the user agent with an HTTP status code 200.
(Content A)
<! DOCTYPE html><html lang=“en”><head><meta charset=“UTF-8”><meta http-equiv=“refresh” content=“0; URL='{value of URL of transfer server}'”><title>Redirecting . . . </title></head><body>Redirecting . . . </body></html>

The user agent receives the content A, and automatically jumps (is transferred) to the URL of the transfer server 10. When operation with SameSite=Strict, which is a strict limitation in a Set-Cookie directive, is desired, a constraint of Cross-Origin Resource Sharing (CORS) occurs in an extension of redirection from the authorization server 90. The transfer server 10 cannot obtain a cookie provided by the transfer server 10. However, as described above, by terminating redirection once and causing the user agent to execute a new request addressed to the transfer server 10, the transfer server 10 can obtain the transfer destination information (cookie).

In step S404, the transfer server 10 (i.e., the response transferring unit 18) holds, in the session information, the authorization code obtained from the authorization server 90 via the user agent. In step S405, the user agent generates a new request based on the content transmitted in step S404. Specifically, the user agent that has received the content transmits an HTTP message (GET message or POST message) to the transfer server 10. The transfer destination information (origin_uri) may be presented to the transfer server 10 by the HTTP message. In this case, the transfer destination obtaining unit 12 obtains the transfer destination information from a notification message (the HTTP message) of the transfer destination information and that is received by the transfer server 10 after the response parameters are received by the transfer-apparatus-side response receiving unit 17. For example, the transfer destination obtaining unit 12 obtains the transfer destination information from a request body of the POST message. After the redirection is terminated, an entity that presents the transfer destination information to the transfer server 10 is not limited to the user agent, and may be the client 31 or another application (apparatus). In step S406, the transfer server 10 (i.e., the response transferring unit 18) that has received the HTTP message transfers the authorization code held in the session information. For transfer of the authorization code, “302 redirect” or “307 Temporary Redirect” is used. In step S407, the user agent transfers the authorization code to the client 31 using an HTTP message (GET message or POST message). In step S408, the client 31 makes, to the user agent, a response (200 OK response) notifying the user agent that the request is successful. Since the processing of steps S402 and S403 is the same as the processing of steps S111 and S112 in FIG. 6, detailed description thereof is omitted.

In step S404, instead of the content A, content B below may be returned to the user agent. The precondition in this case is that the transfer server 10 has obtained the “origin_uri” parameter from information such as the cookie.
(Content B)
<! DOCTYPE html><html lang=“en”><head><meta charset=“UTF-8”><meta http-equiv=“refresh” content=“0; URL='{value of origin_uri parameter}?code={value of authorization code}'”><title>Redirecting . . . </title></head><body>Redirecting . . . </body></ html>

As described above, the content B includes the “origin_uri” parameter and the authorization code issued by the authorization server 90. When the user agent receives the content B, the user agent automatically jumps (is transferred) to the origin_uri. That is, while responding with status code 200, the transfer server 10 (i.e., the response transferring unit 18) can deliver the authorization code to the client 31 without generating a re-request to the transfer server 10. In this case, the processing of steps S405 to S408 in FIG. 19 may be omitted. In another method, JavaScript may be used to allow a user to designate the “origin_uri” parameter. As described above, the transfer destination information is presented to the transfer server 10 after redirection is terminated. Even in such a configuration, the same advantageous effects as those of the above embodiment can be achieved.

### Third Variation

In the above embodiment, the case has been described where the transfer server 10 transfers the group of request parameters and the group of response parameters. However, the group of request parameters is not necessarily transferred by the transfer server 10. That is, the authorization request may be made without intervention of the transfer server 10. In the present variation, a case will be described where an authorization request is made without intervention of the transfer server 10 but an authorization response is made via the transfer server 10. In the description of the present variation below, the description of the configuration common to the above-described embodiment is omitted, and differences from the above-described embodiment will be described. A configuration of a system according to the present variation is substantially the same as the system configuration illustrated in FIG. 1, and the description thereof is omitted. A functional configuration of the system according to the present variation is substantially the same as the functional configuration of the system illustrated in FIG. 2, and the description thereof is omitted. In the present variation, the transfer-apparatus-side request receiving unit 11, the storage processing executing unit 13, the destination information obtaining unit 14, the destination determining unit 15, and the transfer-apparatus-side request transmitting unit 16 may be omitted. Differences from the contents described in the above embodiment will be described below.

The transfer destination obtaining unit 12 obtains the transfer destination information via the user agent from the authorization server 90 that has received an authorization request including the transfer destination information. In the present variation, the transfer destination information (“origin_uri”) is included in the authorization request transmitted to the authorization server 90. The authorization server 90 transmits, to the web browser 51, an authorization response message including the transfer destination information as the URI parameter to redirect the web browser 51 to the transfer server 10. This allows the transfer server 10 (i.e., the transfer destination obtaining unit 12) to obtain the transfer destination information transmitted from the authorization server 90 via the web browser 51.

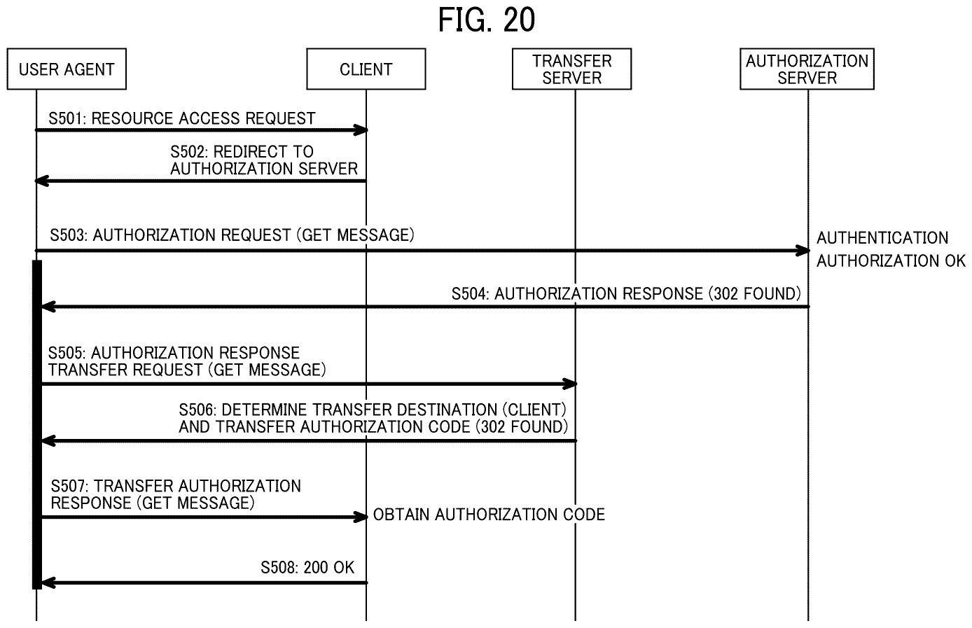

FIG. 20 is a sequence diagram illustrating an example of an overview of a communication process flow in OAuth 2.0 according to the present variation. The process illustrated in this sequence diagram starts in response to, for example, a user pressing a link for requesting cooperation with another service (e.g., a service provided by the resource server 70) or a button in which the link is embedded on a page displayed in the web browser 51 of the terminal 50. As in the sequence diagrams (FIGS. 5 to 7) illustrating the overview of the communication process flow in OAuth 2.0 according to the above embodiment, it is assumed that a registration process of the client 31 in the authorization server 90 is performed as preprocessing prior to the process illustrated in the sequence diagram.

In step S501, access to a resource is requested. Since the processing of step S501 is substantially the same as the processing of step S101 in FIG. 5, detailed description is omitted. In step S502, redirection is made to the authorization server 90. In step S503, an authorization request is made to the authorization server 90 and the authorization server 90 performs the authentication/authorization process. Since the authentication/authorization process performed by the authorization server 90 is the same as the processing of steps S107 to S110 in FIG. 6, detailed description thereof is omitted. In the above embodiment, an authorization request (i.e., authorization request transfer request) is first transmitted to the transfer server 10. In the present variation, the authorization request is transmitted to the authorization server 90 without intervention of the transfer server 10. For example, the web browser 51 transmits an HTTP message (HTTP request) K below to the authorization server 90.
(Message K)
Get https://oauth.example.com/oauth?response_type=code&client_id=AAA&redirect_uri=https://redirector.example.com/callback&scope=BBB&state=CCC&origin_uri=https://192.168.1.10: 8443/get-code

As described above, in the message K, the same redirect URI and “origin_uri” as those of the above embodiment are set. The authorization request according to the present variation is made in the same method as the authorization request of OAuth 2.0 according to the related art, except that the URI of the transfer server 10 is set in the redirect URI and that the transfer parameters (“origin_uri”) are included in addition to the group of request parameters. That is, the client 31 (i.e., the client-side request transmitting unit 32) returns an HTTP message including the group of request parameters and the transfer parameters to the web browser 51 to redirect the web browser 51 to the authorization server 90. The authorization request (i.e., the authorization request message K) is transmitted from the web browser 51 to the authorization server 90.

The authorization server 90 that has received the authorization request makes an authorization response in step S504. For example, the authorization server 90 (i.e., the response transmitting unit 93) transmits an HTTP message L (HTTP request) below.
(Message L)
HTTP/1.1 302 Found Location: https://redirector.example.com/callback?code=XXX&state=CCC&origin_uri=https://192.168.1.10:8443/get-code

As described above, the authorization server 90 makes the authorization response by setting the origin_uri included in the authorization request in a query portion of the “Location” header of the authorization response message. The user agent transmits an authorization response transfer request to the transfer server 10 in step S505. Since the authorization response includes the origin_uri, the authorization response transfer request also includes the origin_uri. The transfer server 10 that has received the authorization response transfer request determines the transfer destination (i.e., the client 31) based on the origin_uri included in the authorization response transfer request and transfers the authorization code in step S506. The user agent transfers the authorization response to the client 31 in step S507. The client 31 makes, to the user agent, a response (200 OK response) notifying the user agent that the request is successful in step S508. Since the processing of steps S506, S507, and S508 is substantially the same as the processing of steps S304, S305, and S306 in FIG. 18, detailed description thereof is omitted.

As described above, the transfer destination information (origin_uri) included in the authorization request is included in the group of response parameters of the authorization response. Even when the transfer server 10 does not intervene in transfer of the authorization request, the transfer server 10 can obtain the transfer destination information and can transfer the authorization code to the redirect destination expected by the client.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. Embodiments achieved by combining at least two of the first to third variations may also be employed.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A transfer apparatus comprising circuitry configured to:
obtain transfer destination information for designating a transfer destination of a response parameter related to an authentication/authorization response to an authentication/authorization request, the authentication/authorization request including an authorization request made for resource access by a client or a user authentication request made by the client;
receive the response parameter included in the authentication/authorization response from an authentication/authorization server via a user agent, the authentication/authorization server being a server to perform authorization for the resource access or to perform user authentication; and
transfer, via the user agent, the received response parameter to the transfer destination indicated by the obtained transfer destination information.

2. The transfer apparatus according to claim 1, wherein
the authentication/authorization server stores information on the transfer apparatus, the information on the transfer apparatus being preregistered for the client in the authentication/authorization server as information on a delivery destination of the response parameter included in the authentication/authorization response, and
the circuitry is configured to receive the response parameter transmitted by the authentication/authorization server, the response parameter being addressed to the transfer apparatus with reference to the information on the transfer apparatus that is the information on the delivery destination.

3. The transfer apparatus according to claim 2, wherein the information on the delivery destination of the response parameter includes a redirect Uniform Resource Identifier.

4. The transfer apparatus according to claim 1, wherein the circuitry is configured to obtain the transfer destination information from the client or the user agent.

5. The transfer apparatus according to claim 4, wherein the circuitry is configured to:
receive one or more request messages for the authentication/authorization request from the client or the user agent; and
obtain the transfer destination information from one request message included in the one or more request messages.

6. The transfer apparatus according to claim 5, wherein the circuitry is configured to:
store the obtained transfer destination information as information related to the authentication/authorization request in a memory; and
transfer the response parameter to the transfer destination indicated by the transfer destination information with reference to the transfer destination information stored in the memory.

7. The transfer apparatus according to claim 4, wherein
the authentication/authorization request includes the transfer destination information, and
the circuitry is configured to obtain the transfer destination information from the user agent that has received the authentication/authorization response including the transfer destination information from the authentication/authorization server that has received the authentication/authorization request including the transfer destination information.

8. The transfer apparatus according to claim 1, wherein the circuitry is configured to obtain the transfer destination information from a notification message of the transfer destination information, the notification message being received by the transfer apparatus after receipt of the response parameter.

9. The transfer apparatus according to claim 1, wherein
the circuitry is configured to:
receive one or more request messages for the authentication/authorization request from the client or the user agent;
instruct the user agent to transmit the authentication/authorization request to the authentication/authorization server, the authentication/authorization request including a request parameter that is related to the authentication/authorization request and included in the received one or more request messages or including information that enables identification of the request parameter, such that the request parameter or the information that enables identification of the request parameter is transmitted to the authentication/authorization server via the user agent.

10. The transfer apparatus according to claim 9, wherein the circuitry is configured to:
obtain destination information that designates the authentication/authorization server as a destination of the authentication/authorization request; and
instruct, using the obtained destination information, the user agent to transmit the authentication/authorization request to the authentication/authorization server indicated by the destination information.

11. The transfer apparatus according to claim 10, wherein the circuitry is configured to:
determine whether the destination indicated by the obtained destination information is a destination permitted as a transmission destination of the authentication/authorization request; and
instruct the user agent to transmit the authentication/authorization request to the authentication/authorization server, based on a determination that the destination indicated by the obtained destination information is a destination permitted as the transmission destination of the authentication/authorization request.

12. The transfer apparatus according to claim 10, wherein the circuitry is configured to obtain the destination information from one request message included in the one or more request messages.

13. The transfer apparatus according to claim 1, wherein the authentication/authorization response includes an authorization code.

14. The transfer apparatus according to claim 1, wherein the transfer destination includes the client.

15. The transfer apparatus according to claim 1, wherein
the authorization request includes an authorization request in Open Authorization 2.0, and
the user authentication request includes an authentication request in OpenID Connect.

16. An information processing system comprising:
an authentication/authorization server to perform authorization for resource access by a client or to perform authentication in response to a user authentication request made by the client; and
a transfer apparatus, wherein the authentication/authorization server includes:
a memory that stores information on the transfer apparatus, the information on the transfer apparatus being stored for the client as information on a delivery destination of a response parameter included in an authentication/authorization response to an authentication/authorization request, the authentication/authorization request including an authorization request made for the resource access by the client or the user authentication request; and
first circuitry configured to:
receive the authentication/authorization request; and
transmit the response parameter to the transfer apparatus via a user agent with reference to the information on the transfer apparatus, and
the transfer apparatus includes second circuitry configured to:
obtain transfer destination information for designating a transfer destination of the response parameter;
receive the response parameter from the authentication/authorization server via the user agent; and
transfer, via the user agent, the received response parameter to the transfer destination indicated by the obtained transfer destination information.

17. A non-transitory recording medium storing a plurality of instructions which, when executed by one or more processors, causes the one or more processors to perform a process comprising:
obtaining transfer destination information for designating a transfer destination of a response parameter related to an authentication/authorization response to an authentication/authorization request, the authentication/authorization request including an authorization request made for resource access by a client or a user authentication request made by the client;
receiving the response parameter included in the authentication/authorization response from an authentication/authorization server via a user agent, the authentication/authorization server being a server to perform authorization for the resource access or to perform user authentication; and
transferring, via the user agent, the received response parameter to the transfer destination indicated by the obtained transfer destination information.

18. A client apparatus comprising:
circuitry configured to transmit transfer destination information for designating a transfer destination of a response parameter related to an authentication/authorization response to allow a transfer apparatus to obtain the transfer destination information,
the transfer apparatus being an apparatus to receive, from an authentication/authorization server, the response parameter included in the authentication/authorization response to an authentication/authorization request, the authentication/authorization request including an authorization request made for resource access by a client or a user authentication request made by the client, the authentication/authorization server being a server to perform authorization for the resource access or to perform user authentication.
